(19) United States
(12) Patent Application Publication
(10) Pub. No.: US 2022/0124310 A1
(43) Pub. Date: Apr. 21, 2022

(54) METHOD AND DEVICE FOR ENCODING/DECODING VIDEO, AND RECORDING MEDIUM FOR STORING BITSTREAM

(71) Applicants: Electronics and Telecommunications Research Institute, Daejeon (KR); UNIVERSITY-INDUSTRY COOPERATION GROUP OF KYUNG HEE UNIVERSITY, Yongin-si Gyeonggi-do (KR)

(72) Inventors: Jung Won KANG, Daejeon (KR); Ha Hyun LEE, Seoul (KR); Sung Chang LIM, Daejeon (KR); Jin Ho LEE, Daejeon (KR); Hui Yong KIM, Daejeon (KR); Gwang Hoon PARK, Seongnam-si Gyeonggi-do (KR); Tae Hyun KIM, Hwaseong-si Gyeonggi-do (KR); Dae Young LEE, Ansan-si Gyeonggi-do (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si Gyeonggi-do (KR)

(21) Appl. No.: 17/432,822

(22) PCT Filed: Feb. 21, 2020
(86) PCT No.: PCT/KR2020/002565

§ 371 Date: Aug. 20, 2021

(30) Foreign Application Priority Data
Feb. 21, 2019 (KR) 10-2019-0020536
Feb. 21, 2019 (KR) 10-2019-0020537

(51) Int. Cl. H04N 19/105; H04N 19/137; H04N 19/176; H04N 19/119

(52) U.S. Cl. CPC H04N 19/105; H04N 19/119; H04N 19/176; H04N 19/137

(57) ABSTRACT

Disclosed herein is an image encoding/decoding method. The method of decoding the image includes structuring a motion information candidate list of a current block, selecting a first motion information candidate used for prediction of a first subblock in the current block from the motion information candidate list, selecting a second motion information candidate used for prediction of a second subblock in the current block from the motion information candidate list, generating a prediction sample of the first subblock by performing inter prediction with respect to the first subblock based on the first motion information candidate, and generating a prediction sample of the second subblock by performing inter prediction with the second subblock based on the second motion information candidate. The first motion information candidate is any one of candidates in a first prediction direction in the motion information candidate list, and the second motion information candidate is any one of candidates in a second prediction direction in the motion information candidate list.

### TECHNICAL FIELD

The present invention relates to an image encoding/decoding method and apparatus, and a recording medium for storing a bitstream. More particularly, the present invention relates to a method and apparatus in which candidate restructuring is used in a process of encoding and decoding a subblock using a shared candidate.

### BACKGROUND ART

Recently, the demand for high resolution and quality images such as high definition (HD) or ultra-high definition (UHD) images has increased in various applications. As the resolution and quality of images are improved, the amount of data correspondingly increases. This is one of the causes of increase in transmission cost and storage cost when transmitting image data through existing transmission media such as wired or wireless broadband channels or when storing image data. In order to solve such problems with high resolution and quality image data, a high efficiency image encoding/decoding technique is required.

There are various video compression techniques such as an inter prediction technique of predicting the values of pixels within a current picture from the values of pixels within a preceding picture or a subsequent picture, an intra prediction technique of predicting the values of pixels within a region of a current picture from the values of pixels within another region of the current picture, a transform and quantization technique of compressing the energy of a residual signal, and an entropy coding technique of allocating frequently occurring pixel values with shorter codes and less occurring pixel values with longer codes.

### DISCLOSURE

### Technical Problem

An object of the present invention is to provide an image encoding/decoding method and apparatus with improved encoding/decoding efficiency.

Another object of the present invention is to provide an image encoding/decoding method and apparatus with increased entropy coding efficiency, by selecting and using only valid candidates from among shared motion candidates according to each block.

Another object of the present invention is to provide an image encoding/decoding method and apparatus with increased entropy coding efficiency, by giving priority to shared motion candidates to be suitable for each block and concentrating a signal indicating candidates selected for motion prediction.

Another object of the present invention is to increase selectivity of a most probable mode (MPM) using a small number of intra prediction modes in a block having a small size.

Another object of the present invention is to provide an image encoding/decoding method and apparatus capable of reducing the amount of signaled bits by reducing the number of representation bits of intra prediction modes.

Another object of the present invention is to provide a recording medium for storing a bitstream generated by an image decoding method or apparatus according to the present invention.

### Technical Solution

A method of decoding an image according to an embodiment of the present invention includes structuring a motion information candidate list of a current block, selecting a first motion information candidate used for prediction of a first subblock in the current block from the motion information candidate list, selecting a second motion information candidate used for prediction of a second subblock in the current block from the motion information candidate list, generating a prediction sample of the first subblock by performing inter prediction with respect to the first subblock based on the first motion information candidate, and generating a prediction sample of the second subblock by performing inter prediction with the second subblock based on the second motion information candidate. The first motion information candidate is any one of candidates in a first prediction direction in the motion information candidate list, and the second motion information candidate is any one of candidates in a second prediction direction in the motion information candidate list.

In the image decoding method, the method may further include obtaining a first index for the first subblock and a second index for the second subblock from a bitstream, the first index may be used for selecting the first motion information candidate from among the candidates in the first prediction direction, and the second index may be used for selecting the second motion information candidate from among the candidates in the second prediction direction.

In the image decoding method, the motion information candidate list may include at least one of motion information of a spatial neighbor block, motion information of a temporal neighbor block, combined motion information or zero motion information.

In the image decoding method, the first index and the second index may be different.

In the image decoding method, the first prediction direction may be determined based on the first index, and the second prediction direction may be determined based on the second index.

In the image decoding method, the first prediction direction may be determined as an L0 direction when the first index is an even number, and the second prediction direction may be determined as an L0 direction when the second index is an even number.

In the image decoding method, the first prediction direction may be determined as an L1 direction when the first index is an odd number, and the second prediction direction may be determined as an L1 direction when the second index is an odd number.

In the image decoding method, the method may further include obtaining indices of partitioning directions of the current block from a bitstream, and the number of partitioning directions may be 64.

In the image decoding method, the method may include predicting the current block by weighted-summing the prediction sample of the first subblock and the prediction sample of the second subblock on boundaries of the first subblock and the second subblock.

A method of coding an image according to an embodiment of the present invention includes structuring a motion information candidate list of a current block, selecting a first motion information candidate used for prediction of a first subblock in the current block from the motion information candidate list, and selecting a second motion information candidate used for prediction of a second subblock in the current block from the motion information candidate list. The first motion information candidate is any one of candidates in a first prediction direction in the motion information candidate list, and the second motion information candidate is any one of candidates in a second prediction direction in the motion information candidate list.

In the image coding method, the method may further include coding a first index for the first subblock and a second index for the second subblock, the first index may be used for selecting the first motion information candidate from the motion information candidate list, and the second index may be used for selecting the second motion information candidate from the motion information candidate list.

In the image decoding method, the motion information candidate list may include at least one of motion information of a spatial neighbor block, motion information of a temporal neighbor block, combined motion information or zero motion information.

In the image decoding method, the first index and the second index may be different.

In the image decoding method, the first prediction direction may be determined based on the first index, and the second prediction direction may be determined based on the second index.

In the image decoding method, the first prediction direction may be determined as an L0 direction when the first index is an even number, and the second prediction direction may be determined as an L0 direction when the second index is an even number.

In the image decoding method, the first prediction direction may be determined as an L1 direction when the first index is an odd number, and the second prediction direction may be determined as an L1 direction when the second index is an odd number.

In the image decoding method, the method may further include coding indices of partitioning directions of the current block, and the number of partitioning directions is 64.

In a non-transitory computer-readable recording medium for storing a bitstream generated by a method of coding an image according to an embodiment of the present invention, the method includes structuring a motion information candidate list of a current block, selecting a first motion information candidate used for prediction of a first subblock in the current block from the motion information candidate list, and selecting a second motion information candidate used for prediction of a second subblock in the current block from the motion information candidate list. The first motion information candidate is any one of candidates in a first prediction direction in the motion information candidate list, and the second motion information candidate is any one of candidates in a second prediction direction in the motion information candidate list.

### Advantageous Effects

According to the present invention, it is possible to provide an image encoding/decoding method and apparatus with improved encoding/decoding efficiency.

According to the present invention, it is possible to provide an image encoding/decoding method and apparatus with increased entropy coding efficiency, by selecting and using only valid candidates from among shared motion candidates according to each block.

According to the present invention, it is possible to provide an image encoding/decoding method and apparatus with increased entropy coding efficiency, by giving priority to shared motion candidates to be suitable for each block and concentrating a signal indicating candidates selected for motion prediction.

According to the present invention, it is possible to increase selectivity of a most probable mode (MPM) using a small number of intra prediction modes in a block having a small size.

According to the present invention, since the amount of signaled bits is reduced by reducing the number of representation bits of intra prediction modes, it is possible to increase the compression rate of an image encoder/decoder.

According to the present invention, it is possible to provide a recording medium for storing a bitstream generated by an image coding method or apparatus according to the present invention.

According to the present invention, it is possible to provide a recording medium for storing a bitstream received and decoded by an image decoding apparatus according to the present invention and used to restructure an image.

### DESCRIPTION OF DRAWINGS

FIG. 1 is a block diagram showing a configuration of an encoding apparatus according to an embodiment to which the present invention is applied.

FIG. 2 is a block diagram showing a configuration of a decoding apparatus according to an embodiment and to which the present invention is applied.

FIG. 3 is a view schematically showing a partition structure of an image when encoding and decoding the image.

FIG. 4 is a view showing an intra-prediction process.

FIG. 5 is a diagram illustrating an embodiment of an inter-picture prediction process.

FIG. 6 is a diagram illustrating a transform and quantization process.

FIG. 7 is a diagram illustrating reference samples capable of being used for intra prediction.

FIG. 8 is a flowchart illustrating a case where a candidate restructuring process is not included and a case where a candidate restructuring process is included in a coding and decoding process using shared candidates according to an embodiment of the present invention.

FIG. 9 is a diagram of a case where a candidate restructuring process is not included and a case where a candidate restructuring process is included in a coding and decoding process using shared candidates according to an embodiment of the present invention.

FIG. 10 is a diagram illustrating an embodiment of a method of structuring a sub candidate list from a shared candidate list.

FIG. 11 is a view illustrating an embodiment of a method of restructuring the codes of candidates for each block for a candidate restructuring process.

FIG. 12 is a diagram illustrating a method of excluding the repetitive use of candidates according to an embodiment of the present invention.

FIG. 13 is a diagram illustrating a method of determining candidates when validity of the shared candidates varies according to the position of the block according to an embodiment of the present invention.

FIG. 14 is a diagram illustrating a method of selecting valid candidates in each block when candidates having the same motion information are present in shared candidates, according to an embodiment of the present invention.

FIG. 15 is a diagram illustrating a method of predicting block partitioning by using candidates having the same motion information among shared candidates according to an embodiment of the present invention.

FIG. 16 is a view illustrating an image decoding method according to an embodiment of the present invention.

FIG. 17 is a view illustrating an image coding method according to an embodiment of the present invention.

FIG. 18 is a view illustrating an embodiment of an intra prediction mode used in image compression technology.

FIG. 19 is a view illustrating an embodiment of a prediction method according to a directional intra prediction mode.

FIG. 20 is a view illustrating a method of reducing the number of intra prediction modes in intra prediction of a small block, according to an embodiment of the present invention.

FIG. 21 is a view illustrating a method of omitting a cost deriving and comparing process with respect to an odd-numbered intra prediction mode when a current block is a small block, according to an embodiment of the present invention.

FIG. 22 is a view illustrating a method of not adding an odd-numbered intra prediction mode to the MPM upon structuring the MPM when the current block is a small block, according to an embodiment of the present invention.

FIG. 23 is a view illustrating a method of correcting an odd-numbered intra prediction mode to an even-numbered intra prediction mode upon structuring the MPM when the current block is a small block, according to an embodiment of the present invention.

FIG. 24 is a view illustrating a method of adding an even-numbered intra prediction mode to the MPM upon structuring the MPM when the current block is a small block, according to an embodiment of the present invention.

FIG. 25 is a view illustrating a method of using only even-numbered intra prediction modes to perform non-MPM encoding/decoding when the current block is a small block, according to an embodiment of the present invention.

FIG. 26 is a view illustrating a method of omitting a cost deriving and comparing process with respect to an even-numbered intra prediction mode when a current block is a small block, according to an embodiment of the present invention.

FIG. 27 is a view illustrating a method of not adding an even-numbered intra prediction mode to the MPM upon structuring the MPM when the current block is a small block, according to an embodiment of the present invention.

FIG. 28 is a view illustrating a method of correcting an even-numbered intra prediction mode to an odd-numbered intra prediction mode upon structuring the MPM when the current block is a small block, according to an embodiment of the present invention.

FIG. 29 is a view illustrating a method of adding an odd-numbered intra prediction mode to the MPM upon structuring the MPM when the current block is a small block, according to an embodiment of the present invention.

FIG. 30 is a view illustrating a method of using only odd-numbered intra prediction modes to perform non-MPM encoding/decoding when the current block is a small block, according to an embodiment of the present invention.

FIG. 31 is a view illustrating a method of omitting a cost deriving and comparing process with respect some intra prediction modes which are predetermined not to be used when a current block is a small block, according to an embodiment of the present invention.

FIG. 32 is a view illustrating a method of not adding some intra prediction modes which are predetermined not to be used to the MPM upon structuring the MPM when the current block is a small block, according to an embodiment of the present invention.

FIG. 33 is a view illustrating a method of correcting some intra prediction modes which are predetermined not to be used to the other modes upon structuring the MPM when the current block is a small block, according to an embodiment of the present invention.

FIG. 34 is a view illustrating a method of adding the intra prediction candidate mode except for the intra prediction candidate mode predetermined not to be used to the MPM upon structuring the MPM when the current block is a small block, according to an embodiment of the present invention.

FIG. 35 is a view illustrating a method of using only some intra prediction modes to perform non-MPM encoding/decoding when the current block is a small block, according to an embodiment of the present invention.

FIG. 36 is a view showing an embodiment in which the intra prediction mode number is allocated.

FIG. 37 is a view illustrating a method of using the intra prediction mode number reallocated according to directionality when the current block is a small block, according to an embodiment of the present invention.

FIG. 38 is a view illustrating a method of structuring an MPM using candidates suitable for a small block upon structuring the MPM when the current block is a small block, according to an embodiment of the present invention.

FIG. 39 is a view illustrating a method of using intra prediction modes less in number than the number of existing intra prediction modes to perform non-MPM encoding/decoding when the current block is a small block, according to an embodiment of the present invention.

FIG. 40 is a view showing the configuration of a encoder/decoder in which a restructured intra prediction mode is used when the current block is a small block, according to an embodiment of the present invention.

FIG. 41 is a view showing structuring in which an intra prediction mode restructuring unit is applied to an intra prediction unit, according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

Hereinafter, an image may mean a picture configuring a video, or may mean the video itself. For example, “encoding or decoding or both of an image” may mean “encoding or decoding or both of a moving picture”, and may mean “encoding or decoding or both of one image among images of a moving picture.”

Hereinafter, terms “moving picture” and “video” may be used as the same meaning and be replaced with each other.

Hereinafter, a target image may be an encoding target image which is a target of encoding and/or a decoding target image which is a target of decoding. Also, a target image may be an input image inputted to an encoding apparatus, and an input image inputted to a decoding apparatus. Here, a target image may have the same meaning with the current image.

Hereinafter, terms “image”, “picture, “frame” and “screen” may be used as the same meaning and be replaced with each other.

Hereinafter, a target block may be an encoding target block which is a target of encoding and/or a decoding target block which is a target of decoding. Also, a target block may be the current block which is a target of current encoding and/or decoding. For example, terms “target block” and “current block” may be used as the same meaning and be replaced with each other.

Hereinafter, terms “block” and “unit” may be used as the same meaning and be replaced with each other. Or a “block” may represent a specific unit.

Hereinafter, terms “region” and “segment” may be replaced with each other.

Hereinafter, a specific signal may be a signal representing a specific block. For example, an original signal may be a signal representing a target block. A prediction signal may be a signal representing a prediction block. A residual signal may be a signal representing a residual block.

In embodiments, each of specific information, data, flag, index, element and attribute, etc. may have a value. A value of information, data, flag, index, element and attribute equal to “0” may represent a logical false or the first predefined value. In other words, a value “0”, a false, a logical false and the first predefined value may be replaced with each other. A value of information, data, flag, index, element and attribute equal to “1” may represent a logical true or the second predefined value. In other words, a value “1”, a true, a logical true and the second predefined value may be replaced with each other.

When a variable i or j is used for representing a column, a row or an index, a value of i may be an integer equal to or greater than 0, or equal to or greater than 1. That is, the column, the row, the index, etc. may be counted from 0 or may be counted from 1.

### Description of Terms

Encoder: means an apparatus performing encoding. That is, means an encoding apparatus.

Decoder: means an apparatus performing decoding. That is, means a decoding apparatus.

Block: is an M×N array of a sample. Herein, M and N may mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit constituting a block. It may be expressed as a value from 0 to 2^{Bd}−1 according to a bit depth (B_{d}). In the present invention, the sample may be used as a meaning of a pixel. That is, a sample, a pel, a pixel may have the same meaning with each other.

Unit: may refer to an encoding and decoding unit. When encoding and decoding an image, the unit may be a region generated by partitioning a single image. In addition, the unit may mean a subdivided unit when a single image is partitioned into subdivided units during encoding or decoding. That is, an image may be partitioned into a plurality of units. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a square shape, a rectangular shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method, a binary tree partitioning method and ternary-tree partitioning method to configure a lower unit such as coding unit, prediction unit, transform unit, etc. It may be used as a term for designating a sample block that becomes a process unit when encoding/decoding an image as an input image. Here, the quad-tree may mean a quaternary-tree.

When the size of the coding block is within a predetermined range, the division is possible using only quad-tree partitioning. Here, the predetermined range may be defined as at least one of a maximum size and a minimum size of a coding block in which the division is possible using only quad-tree partitioning. Information indicating a maximum/minimum size of a coding block in which quad-tree partitioning is allowed may be signaled through a bitstream, and the information may be signaled in at least one unit of a sequence, a picture parameter, a tile group, or a slice (segment). Alternatively, the maximum/minimum size of the coding block may be a fixed size predetermined in the encoder/decoder. For example, when the size of the coding block corresponds to 256×256 to 64×64, the division is possible only using quad-tree partitioning. Alternatively, when the size of the coding block is larger than the size of the maximum conversion block, the division is possible only using quad-tree partitioning. Herein, the block to be divided may be at least one of a coding block and a transform block. In this case, information indicating the division of the coded block (for example, split_flag) may be a flag indicating whether or not to perform the quad-tree partitioning. When the size of the coding block falls within a predetermined range, the division is possible only using binary tree or ternary tree partitioning. In this case, the above description of the quad-tree partitioning may be applied to binary tree partitioning or ternary tree partitioning in the same manner.

Coding Tree Block: may be used as a term for designating any one of a Y coding tree block, Cb coding tree block, and Cr coding tree block.

Neighbor Block: may mean a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: may mean a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at a corresponding position as the current block of the current picture within a reference image, or a neighbor block thereof.

Unit Depth: may mean a partitioned degree of a unit. In a tree structure, the highest node (Root Node) may correspond to the first unit which is not partitioned. Also, the highest node may have the least depth value. In this case, the highest node may have a depth of level 0. A node having a depth of level 1 may represent a unit generated by partitioning once the first unit. A node having a depth of level 2 may represent a unit generated by partitioning twice the first unit. A node having a depth of level n may represent a unit generated by partitioning n-times the first unit. A Leaf Node may be the lowest node and a node which cannot be partitioned further. A depth of a Leaf Node may be the maximum level. For example, a predefined value of the maximum level may be 3. A depth of a root node may be the lowest and a depth of a leaf node may be the deepest. In addition, when a unit is expressed as a tree structure, a level in which a unit is present may mean a unit depth.

Bitstream: may mean a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, a tile group header, and tile header information. The term “tile group” means a group of tiles and has the same meaning as a slice.

An adaptation parameter set may mean a parameter set that can be shared by being referred to in different pictures, subpictures, slices, tile groups, tiles, or bricks. In addition, information in an adaptation parameter set may be used by referring to different adaptation parameter sets for a subpicture, a slice, a tile group, a tile, or a brick inside a picture.

In addition, regarding the adaptation parameter set, different adaptation parameter sets may be referred to by using identifiers of different adaptation parameter sets for a subpicture, a slice, a tile group, a tile, or a brick inside a picture.

In addition, regarding the adaptation parameter set, different adaptation parameter sets may be referred to by using identifiers of different adaptation parameter sets for a slice, a tile group, a tile, or a brick inside a subpicture.

In addition, regarding the adaptation parameter set, different adaptation parameter sets may be referred to by using identifiers of different adaptation parameter sets for a tile or a brick inside a slice.

In addition, regarding the adaptation parameter set, different adaptation parameter sets may be referred to by using identifiers of different adaptation parameter sets for a brick inside a tile.

Information on an adaptation parameter set identifier may be included in a parameter set or a header of the subpicture, and an adaptation parameter set corresponding to the adaptation parameter set identifier may be used for the subpicture.

The information on the adaptation parameter set identifier may be included in a parameter set or a header of the tile, and an adaptation parameter set corresponding to the adaptation parameter set identifier may be used for the tile.

The information on the adaptation parameter set identifier may be included in a header of the brick, and an adaptation parameter set corresponding to the adaptation parameter set identifier may be used for the brick.

The picture may be partitioned into one or more tile rows and one or more tile columns.

The subpicture may be partitioned into one or more tile rows and one or more tile columns within a picture. The subpicture may be a region having the form of a rectangle/square within a picture and may include one or more CTUs. In addition, at least one or more tiles/bricks/slices may be included within one subpicture.

The tile may be a region having the form of a rectangle/square within a picture and may include one or more CTUs. In addition, the tile may be partitioned into one or more bricks.

The brick may mean one or more CTU rows within a tile. The tile may be partitioned into one or more bricks, and each brick may have at least one or more CTU rows. A tile that is not partitioned into two or more may mean a brick.

The slice may include one or more tiles within a picture and may include one or more bricks within a tile.

Parsing: may mean determination of a value of a syntax element by performing entropy decoding, or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Mode: may be information indicating a mode encoded/decoded with intra prediction or a mode encoded/decoded with inter prediction.

Prediction Unit: may mean a basic unit when performing prediction such as inter-prediction, intra-prediction, inter-compensation, intra-compensation, and motion compensation. A single prediction unit may be partitioned into a plurality of partitions having a smaller size, or may be partitioned into a plurality of lower prediction units. A plurality of partitions may be a basic unit in performing prediction or compensation. A partition which is generated by dividing a prediction unit may also be a prediction unit.

Prediction Unit Partition: may mean a form obtained by partitioning a prediction unit.

Reference picture list may refer to a list including one or more reference pictures used for inter prediction or motion compensation. There are several types of usable reference picture lists, including LC (List combined), L0 (List 0), L1 (List 1), L2 (List 2), L3 (List 3).

Inter prediction indicator may refer to a direction of inter prediction (unidirectional prediction, bidirectional prediction, etc.) of a current block. Alternatively, it may refer to the number of reference pictures used to generate a prediction block of a current block. Alternatively, it may refer to the number of prediction blocks used at the time of performing inter prediction or motion compensation on a current block.

Prediction list utilization flag indicates whether a prediction block is generated using at least one reference picture in a specific reference picture list. An inter prediction indicator can be derived using a prediction list utilization flag, and conversely, a prediction list utilization flag can be derived using an inter prediction indicator. For example, when the prediction list utilization flag has a first value of zero (0), it means that a reference picture in a reference picture list is not used to generate a prediction block. On the other hand, when the prediction list utilization flag has a second value of one (1), it means that a reference picture list is used to generate a prediction block.

Reference picture index may refer to an index indicating a specific reference picture in a reference picture list.

Reference picture may mean a reference picture which is referred to by a specific block for the purposes of inter prediction or motion compensation of the specific block. Alternatively, the reference picture may be a picture including a reference block referred to by a current block for inter prediction or motion compensation. Hereinafter, the terms “reference picture” and “reference image” have the same meaning and can be interchangeably.

Motion vector may be a two-dimensional vector used for inter prediction or motion compensation. The motion vector may mean an offset between an encoding/decoding target block and a reference block. For example, (mvX, mvY) may represent a motion vector. Here, mvX may represent a horizontal component and mvY may represent a vertical component.

Search range may be a two-dimensional region which is searched to retrieve a motion vector during inter prediction. For example, the size of the search range may be M×N. Here, M and N are both integers.

Motion vector candidate may refer to a prediction candidate block or a motion vector of the prediction candidate block when predicting a motion vector. In addition, a motion vector candidate may be included in a motion vector candidate list.

Motion vector candidate list may mean a list composed of one or more motion vector candidates.

Motion vector candidate index may mean an indicator indicating a motion vector candidate in a motion vector candidate list. Alternatively, it may be an index of a motion vector predictor.

Motion information may mean information including at least one of the items including a motion vector, a reference picture index, an inter prediction indicator, a prediction list utilization flag, reference picture list information, a reference picture, a motion vector candidate, a motion vector candidate index, a merge candidate, and a merge index.

Merge candidate list may mean a list composed of one or more merge candidates.

Merge candidate may mean a spatial merge candidate, a temporal merge candidate, a combined merge candidate, a combined bi-predictive merge candidate, or a zero merge candidate. The merge candidate may include motion information such as an inter prediction indicator, a reference picture index for each list, a motion vector, a prediction list utilization flag, and an inter prediction indicator.

Merge index may mean an indicator indicating a merge candidate in a merge candidate list. Alternatively, the merge index may indicate a block from which a merge candidate has been derived, among reconstructed blocks spatially/temporally adjacent to a current block. Alternatively, the merge index may indicate at least one piece of motion information of a merge candidate.

Transform Unit: may mean a basic unit when performing encoding/decoding such as transform, inverse-transform, quantization, dequantization, transform coefficient encoding/decoding of a residual signal. A single transform unit may be partitioned into a plurality of lower-level transform units having a smaller size. Here, transformation/inverse-transformation may comprise at least one among the first transformation/the first inverse-transformation and the second transformation/the second inverse-transformation.

Scaling: may mean a process of multiplying a quantized level by a factor. A transform coefficient may be generated by scaling a quantized level. The scaling also may be referred to as dequantization.

Quantization Parameter: may mean a value used when generating a quantized level using a transform coefficient during quantization. The quantization parameter also may mean a value used when generating a transform coefficient by scaling a quantized level during dequantization. The quantization parameter may be a value mapped on a quantization step size.

Delta Quantization Parameter: may mean a difference value between a predicted quantization parameter and a quantization parameter of an encoding/decoding target unit.

Scan: may mean a method of sequencing coefficients within a unit, a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform Coefficient: may mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: may mean a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: may mean a transform coefficient having a value other than zero, or a transform coefficient level or a quantized level having a value other than zero.

Quantization Matrix: may mean a matrix used in a quantization process or a dequantization process performed to improve subjective or objective image quality. The quantization matrix also may be referred to as a scaling list.

Quantization Matrix Coefficient: may mean each element within a quantization matrix. The quantization matrix coefficient also may be referred to as a matrix coefficient.

Default Matrix: may mean a predetermined quantization matrix preliminarily defined in an encoder or a decoder.

Non-default Matrix: may mean a quantization matrix that is not preliminarily defined in an encoder or a decoder but is signaled by a user.

Statistic Value: a statistic value for at least one among a variable, a coding parameter, a constant value, etc. which have a computable specific value may be one or more among an average value, a sum value, a weighted average value, a weighted sum value, the minimum value, the maximum value, the most frequent value, a median value, an interpolated value of the corresponding specific values.

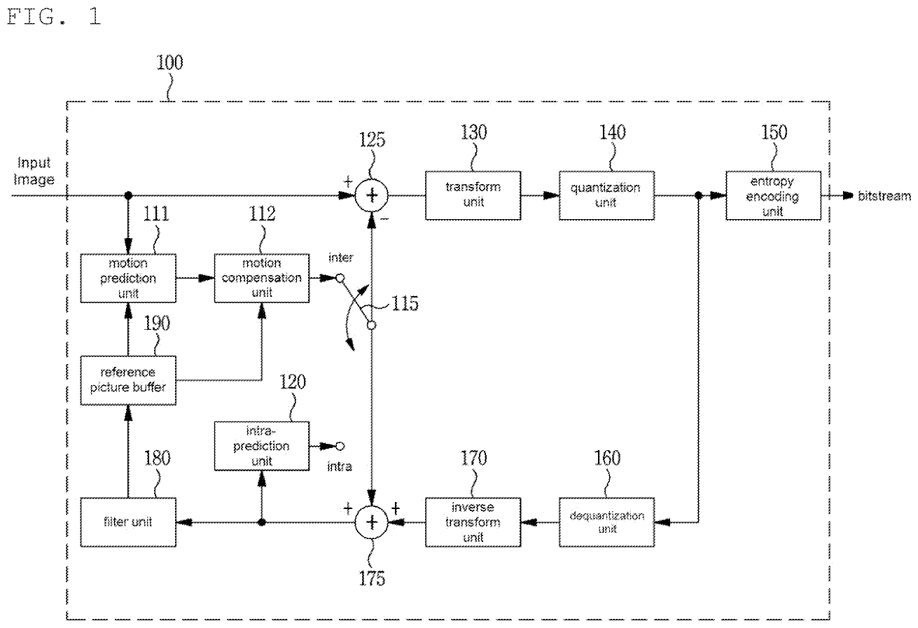

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, an inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream including encoded information through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual block using a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a sample of a block that has been already encoded/decoded and is adjacent to a current block as a reference sample. The intra-prediction unit 120 may perform spatial prediction for the current block by using a reference sample, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 112 may generate a prediction block by performing motion compensation for the current block using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a difference of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of sample information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level (quantized level), the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block shape, unit/block partition structure, whether to partition of a quad tree form, whether to partition of a binary tree form, a partition direction of a binary tree form (horizontal direction or vertical direction), a partition form of a binary tree form (symmetric partition or asymmetric partition), whether or not a current coding unit is partitioned by ternary tree partitioning, direction (horizontal or vertical direction) of the ternary tree partitioning, type (symmetric or asymmetric type) of the ternary tree partitioning, whether a current coding unit is partitioned by multi-type tree partitioning, direction (horizontal or vertical direction) of the multi-type three partitioning, type (symmetric or asymmetric type) of the multi-type tree partitioning, and a tree (binary tree or ternary tree) structure of the multi-type tree partitioning, a prediction mode (intra prediction or inter prediction), a luma intra-prediction mode/direction, a chroma intra-prediction mode/direction, intra partition information, inter partition information, a coding block partition flag, a prediction block partition flag, a transform block partition flag, a reference sample filtering method, a reference sample filter tab, a reference sample filter coefficient, a prediction block filtering method, a prediction block filter tap, a prediction block filter coefficient, a prediction block boundary filtering method, a prediction block boundary filter tab, a prediction block boundary filter coefficient, an intra-prediction mode, an inter-prediction mode, motion information, a motion vector, a motion vector difference, a reference picture index, a inter-prediction angle, an inter-prediction indicator, a prediction list utilization flag, a reference picture list, a reference picture, a motion vector predictor index, a motion vector predictor candidate, a motion vector candidate list, whether to use a merge mode, a merge index, a merge candidate, a merge candidate list, whether to use a skip mode, an interpolation filter type, an interpolation filter tab, an interpolation filter coefficient, a motion vector size, a presentation accuracy of a motion vector, a transform type, a transform size, information of whether or not a primary (first) transform is used, information of whether or not a secondary transform is used, a primary transform index, a secondary transform index, information of whether or not a residual signal is present, a coded block pattern, a coded block flag (CBF), a quantization parameter, a quantization parameter residue, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample offset category, an adaptive sample offset type, whether to apply an adaptive loop filter, an adaptive loop filter coefficient, an adaptive loop filter tab, an adaptive loop filter shape/form, a binarization/inverse-binarization method, a context model determining method, a context model updating method, whether to perform a regular mode, whether to perform a bypass mode, a context bin, a bypass bin, a significant coefficient flag, a last significant coefficient flag, a coded flag for a unit of a coefficient group, a position of the last significant coefficient, a flag for whether a value of a coefficient is larger than 1, a flag for whether a value of a coefficient is larger than 2, a flag for whether a value of a coefficient is larger than 3, information on a remaining coefficient value, a sign information, a reconstructed luma sample, a reconstructed chroma sample, a residual luma sample, a residual chroma sample, a luma transform coefficient, a chroma transform coefficient, a quantized luma level, a quantized chroma level, a transform coefficient level scanning method, a size of a motion vector search area at a decoder side, a shape of a motion vector search area at a decoder side, a number of time of a motion vector search at a decoder side, information on a CTU size, information on a minimum block size, information on a maximum block size, information on a maximum block depth, information on a minimum block depth, an image displaying/outputting sequence, slice identification information, a slice type, slice partition information, tile identification information, a tile type, tile partition information, tile group identification information, a tile group type, tile group partition information, a picture type, a bit depth of an input sample, a bit depth of a reconstruction sample, a bit depth of a residual sample, a bit depth of a transform coefficient, a bit depth of a quantized level, and information on a luma signal or information on a chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image in reference picture buffer 190.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAO), and an adaptive loop filter (ALF) to a reconstructed sample, a reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based samples included in several rows or columns which are included in the block. When a deblocking filter is applied to a block, another filter may be applied according to a required deblocking filtering strength.

In order to compensate an encoding error, a proper offset value may be added to a sample value by using a sample adaptive offset. The sample adaptive offset may correct an offset of a deblocked image from an original image by a sample unit. A method of partitioning samples of an image into a predetermined number of regions, determining a region to which an offset is applied, and applying the offset to the determined region, or a method of applying an offset in consideration of edge information on each sample may be used.

The adaptive loop filter may perform filtering based on a comparison result of the filtered reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

The reconstructed block or the reconstructed image having passed through the filter unit 180 may be stored in the reference picture buffer 190. A reconstructed block processed by the filter unit 180 may be a part of a reference image. That is, a reference image is a reconstructed image composed of reconstructed blocks processed by the filter unit 180. The stored reference image may be used later in inter prediction or motion compensation.

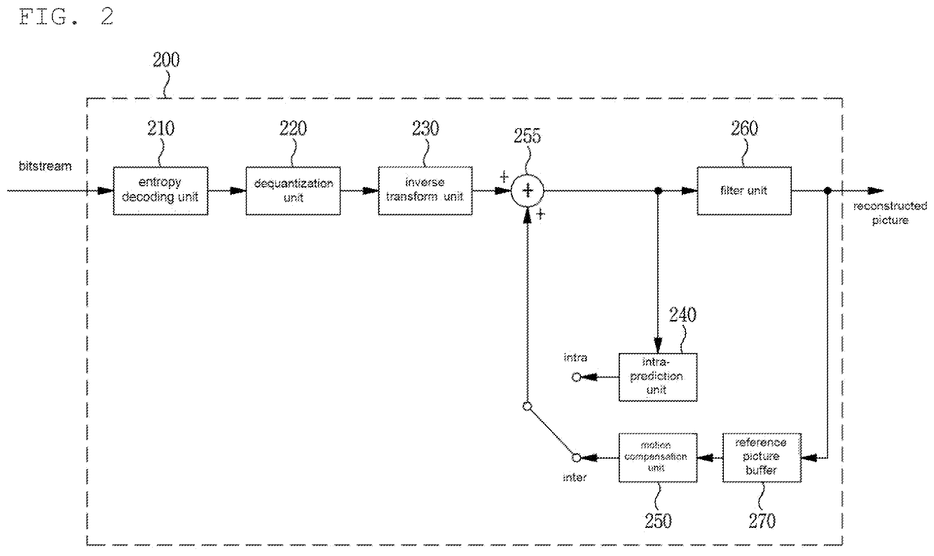

FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse-process of the entropy encoding method described above.

In order to decode a transform coefficient level (quantized level), the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing, for the current block, spatial prediction that uses a sample value of a block adjacent to a decoding target block and which has been already decoded.

When an inter mode is used, the motion compensation unit 250 may generate a prediction block by performing, for the current block, motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction. A reconstructed block processed by the filter unit 260 may be a part of a reference image. That is, a reference image is a reconstructed image composed of reconstructed blocks processed by the filter unit 260. The stored reference image may be used later in inter prediction or motion compensation.

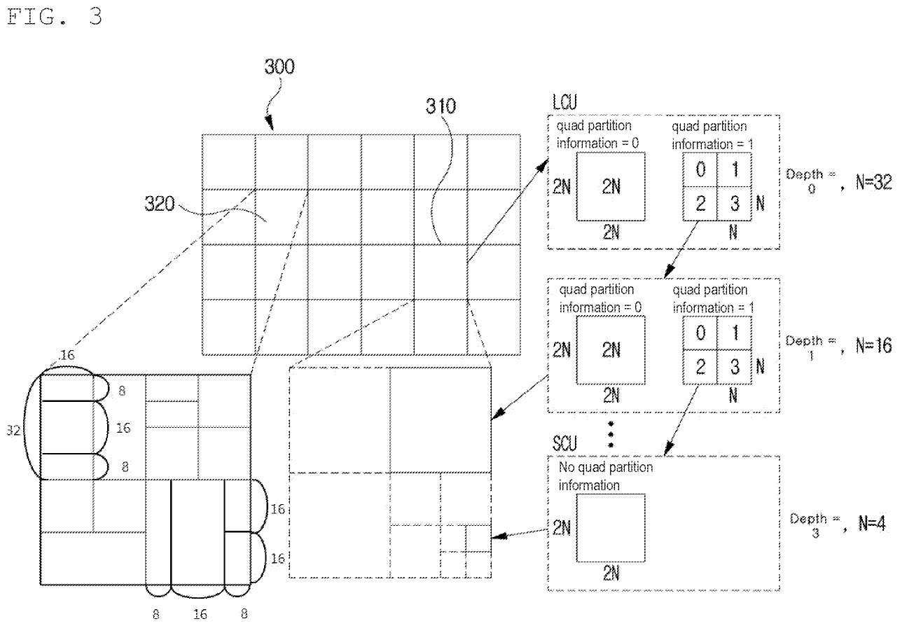

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra prediction mode and an inter prediction mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit may be partitioned into a plurality of lower level units hierarchically associated with depth information based on a tree structure. In other words, a unit and a lower level unit generated by partitioning the unit may correspond to a node and a child node of the node, respectively. Each of partitioned lower unit may have depth information. Depth information may be information representing a size of a CU, and may be stored in each CU. Unit depth represents times and/or degrees related to partitioning a unit. Therefore, partitioning information of a lower-level unit may comprise information on a size of the lower-level unit.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. By the recursive partitioning, at least one among a height and a width of a CU after partitioning may decrease comparing with at least one among a height and a width of a CU before partitioning. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning. For example, for each depth, a CU which is not partitioned may have a size of 2N×2N. Also, in case of a CU which is partitioned, a CU with a size of 2N×2N may be partitioned into four CUs with a size of N×N. A size of N may decrease to half as a depth increase by 1.

In addition, information whether or not the CU is partitioned may be represented by using partition information of the CU. The partition information may be 1-bit information. All CUs, except for a SCU, may include partition information. For example, when a value of partition information is a first value, the CU may not be partitioned, when a value of partition information is a second value, the CU may be partitioned

Referring to FIG. 3, an LCU having a depth 0 may be a 64×64 block. 0 may be a minimum depth. A SCU having a depth 3 may be an 8×8 block. 3 may be a maximum depth. A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit may be partitioned into a quad tree form.

For example, when one coding unit is partitioned into two sub-coding units, the horizontal or vertical size (width or height) of each of the two sub-coding units may be half the horizontal or vertical size of the original coding unit. For example, when a coding unit having a size of 32×32 is vertically partitioned into two sub-coding units, each of the two sub-coding units may have a size of 16×32. For example, when a coding unit having a size of 8×32 is horizontally partitioned into two sub-coding units, each of the two sub-coding units may have a size of 8×16. When one coding unit is partitioned into two sub-coding units, it can be said that the coding unit is binary-partitioned or is partitioned by a binary tree partition structure.

For example, when one coding unit is partitioned into three sub-coding units, the horizontal or vertical size of the coding unit can be partitioned with a ratio of 1:2:1, thereby producing three sub-coding units whose horizontal or vertical sizes are in a ratio of 1:2:1. For example, when a coding unit having a size of 16×32 is horizontally partitioned into three sub-coding units, the three sub-coding units may have sizes of 16×8, 16×16, and 16×8 respectively, in the order from the uppermost to the lowermost sub-coding unit. For example, when a coding unit having a size of 32×32 is vertically split into three sub-coding units, the three sub-coding units may have sizes of 8×32, 16×32, and 8×32, respectively in the order from the left to the right sub-coding unit. When one coding unit is partitioned into three sub-coding units, it can be said that the coding unit is ternary-partitioned or partitioned by a ternary tree partition structure.

In FIG. 3, a coding tree unit (CTU) 320 is an example of a CTU to which a quad tree partition structure, a binary tree partition structure, and a ternary tree partition structure are all applied.

As described above, in order to partition the CTU, at least one of a quad tree partition structure, a binary tree partition structure, and a ternary tree partition structure may be applied. Various tree partition structures may be sequentially applied to the CTU, according to a predetermined priority order. For example, the quad tree partition structure may be preferentially applied to the CTU. A coding unit that cannot be partitioned any longer using a quad tree partition structure may correspond to a leaf node of a quad tree. A coding unit corresponding to a leaf node of a quad tree may serve as a root node of a binary and/or ternary tree partition structure. That is, a coding unit corresponding to a leaf node of a quad tree may be further partitioned by a binary tree partition structure or a ternary tree partition structure, or may not be further partitioned. Therefore, by preventing a coding unit that results from binary tree partitioning or ternary tree partitioning of a coding unit corresponding to a leaf node of a quad tree from undergoing further quad tree partitioning, block partitioning and/or signaling of partition information can be effectively performed.

The fact that a coding unit corresponding to a node of a quad tree is partitioned may be signaled using quad partition information. The quad partition information having a first value (e.g., “1”) may indicate that a current coding unit is partitioned by the quad tree partition structure. The quad partition information having a second value (e.g., “0”) may indicate that a current coding unit is not partitioned by the quad tree partition structure. The quad partition information may be a flag having a predetermined length (e.g., one bit).

There may not be a priority between the binary tree partitioning and the ternary tree partitioning. That is, a coding unit corresponding to a leaf node of a quad tree may further undergo arbitrary partitioning among the binary tree partitioning and the ternary tree partitioning. In addition, a coding unit generated through the binary tree partitioning or the ternary tree partitioning may undergo a further binary tree partitioning or a further ternary tree partitioning, or may not be further partitioned.

A tree structure in which there is no priority among the binary tree partitioning and the ternary tree partitioning is referred to as a multi-type tree structure. A coding unit corresponding to a leaf node of a quad tree may serve as a root node of a multi-type tree. Whether to partition a coding unit which corresponds to a node of a multi-type tree may be signaled using at least one of multi-type tree partition indication information, partition direction information, and partition tree information. For partitioning of a coding unit corresponding to a node of a multi-type tree, the multi-type tree partition indication information, the partition direction, and the partition tree information may be sequentially signaled.

The multi-type tree partition indication information having a first value (e.g., “1”) may indicate that a current coding unit is to undergo a multi-type tree partitioning. The multi-type tree partition indication information having a second value (e.g., “0”) may indicate that a current coding unit is not to undergo a multi-type tree partitioning.

When a coding unit corresponding to a node of a multi-type tree is further partitioned by a multi-type tree partition structure, the coding unit may include partition direction information. The partition direction information may indicate in which direction a current coding unit is to be partitioned for the multi-type tree partitioning. The partition direction information having a first value (e.g., “1”) may indicate that a current coding unit is to be vertically partitioned. The partition direction information having a second value (e.g., “0”) may indicate that a current coding unit is to be horizontally partitioned.

When a coding unit corresponding to a node of a multi-type tree is further partitioned by a multi-type tree partition structure, the current coding unit may include partition tree information. The partition tree information may indicate a tree partition structure which is to be used for partitioning of a node of a multi-type tree. The partition tree information having a first value (e.g., “1”) may indicate that a current coding unit is to be partitioned by a binary tree partition structure. The partition tree information having a second value (e.g., “0”) may indicate that a current coding unit is to be partitioned by a ternary tree partition structure.

The partition indication information, the partition tree information, and the partition direction information may each be a flag having a predetermined length (e.g., one bit).

At least any one of the quadtree partition indication information, the multi-type tree partition indication information, the partition direction information, and the partition tree information may be entropy encoded/decoded. For the entropy-encoding/decoding of those types of information, information on a neighboring coding unit adjacent to the current coding unit may be used. For example, there is a high probability that the partition type (the partitioned or non-partitioned, the partition tree, and/or the partition direction) of a left neighboring coding unit and/or an upper neighboring coding unit of a current coding unit is similar to that of the current coding unit. Therefore, context information for entropy encoding/decoding of the information on the current coding unit may be derived from the information on the neighboring coding units. The information on the neighboring coding units may include at least any one of quad partition information, multi-type tree partition indication information, partition direction information, and partition tree information.

As another example, among binary tree partitioning and ternary tree partitioning, binary tree partitioning may be preferentially performed. That is, a current coding unit may primarily undergo binary tree partitioning, and then a coding unit corresponding to a leaf node of a binary tree may be set as a root node for ternary tree partitioning. In this case, neither quad tree partitioning nor binary tree partitioning may not be performed on the coding unit corresponding to a node of a ternary tree.

A coding unit that cannot be partitioned by a quad tree partition structure, a binary tree partition structure, and/or a ternary tree partition structure becomes a basic unit for coding, prediction and/or transformation. That is, the coding unit cannot be further partitioned for prediction and/or transformation. Therefore, the partition structure information and the partition information used for partitioning a coding unit into prediction units and/or transformation units may not be present in a bit stream.

However, when the size of a coding unit (i.e., a basic unit for partitioning) is larger than the size of a maximum transformation block, the coding unit may be recursively partitioned until the size of the coding unit is reduced to be equal to or smaller than the size of the maximum transformation block. For example, when the size of a coding unit is 64×64 and when the size of a maximum transformation block is 32×32, the coding unit may be partitioned into four 32×32 blocks for transformation. For example, when the size of a coding unit is 32×64 and the size of a maximum transformation block is 32×32, the coding unit may be partitioned into two 32×32 blocks for the transformation. In this case, the partitioning of the coding unit for transformation is not signaled separately, and may be determined through comparison between the horizontal or vertical size of the coding unit and the horizontal or vertical size of the maximum transformation block. For example, when the horizontal size (width) of the coding unit is larger than the horizontal size (width) of the maximum transformation block, the coding unit may be vertically bisected. For example, when the vertical size (height) of the coding unit is larger than the vertical size (height) of the maximum transformation block, the coding unit may be horizontally bisected.

Information of the maximum and/or minimum size of the coding unit and information of the maximum and/or minimum size of the transformation block may be signaled or determined at an upper level of the coding unit. The upper level may be, for example, a sequence level, a picture level, a slice level, a tile group level, a tile level, or the like. For example, the minimum size of the coding unit may be determined to be 4×4. For example, the maximum size of the transformation block may be determined to be 64×64. For example, the minimum size of the transformation block may be determined to be 4×4.

Information of the minimum size (quad tree minimum size) of a coding unit corresponding to a leaf node of a quad tree and/or information of the maximum depth (the maximum tree depth of a multi-type tree) from a root node to a leaf node of the multi-type tree may be signaled or determined at an upper level of the coding unit. For example, the upper level may be a sequence level, a picture level, a slice level, a tile group level, a tile level, or the like. Information of the minimum size of a quad tree and/or information of the maximum depth of a multi-type tree may be signaled or determined for each of an intra-picture slice and an inter-picture slice.

Difference information between the size of a CTU and the maximum size of a transformation block may be signaled or determined at an upper level of the coding unit. For example, the upper level may be a sequence level, a picture level, a slice level, a tile group level, a tile level, or the like. Information of the maximum size of the coding units corresponding to the respective nodes of a binary tree (hereinafter, referred to as a maximum size of a binary tree) may be determined based on the size of the coding tree unit and the difference information. The maximum size of the coding units corresponding to the respective nodes of a ternary tree (hereinafter, referred to as a maximum size of a ternary tree) may vary depending on the type of slice. For example, for an intra-picture slice, the maximum size of a ternary tree may be 32×32. For example, for an inter-picture slice, the maximum size of a ternary tree may be 128×128. For example, the minimum size of the coding units corresponding to the respective nodes of a binary tree (hereinafter, referred to as a minimum size of a binary tree) and/or the minimum size of the coding units corresponding to the respective nodes of a ternary tree (hereinafter, referred to as a minimum size of a ternary tree) may be set as the minimum size of a coding block.

As another example, the maximum size of a binary tree and/or the maximum size of a ternary tree may be signaled or determined at the slice level. Alternatively, the minimum size of the binary tree and/or the minimum size of the ternary tree may be signaled or determined at the slice level.

Depending on size and depth information of the above-described various blocks, quad partition information, multi-type tree partition indication information, partition tree information and/or partition direction information may be included or may not be included in a bit stream.

For example, when the size of the coding unit is not larger than the minimum size of a quad tree, the coding unit does not contain quad partition information. The quad partition information may be deduced as a second value.

For example, when the sizes (horizontal and vertical sizes) of a coding unit corresponding to a node of a multi-type tree are larger than the maximum sizes (horizontal and vertical sizes) of a binary tree and/or the maximum sizes (horizontal and vertical sizes) of a ternary tree, the coding unit may not be binary-partitioned or ternary-partitioned. Accordingly, the multi-type tree partition indication information may not be signaled but may be deduced from a second value.

Alternatively, when the sizes (horizontal and vertical sizes) of a coding unit corresponding to a node of a multi-type tree are the same as the maximum sizes (horizontal and vertical sizes) of a binary tree and/or are two times as large as the maximum sizes (horizontal and vertical sizes) of a ternary tree, the coding unit may not be further binary-partitioned or ternary-partitioned. Accordingly, the multi-type tree partition indication information may not be signaled but be derived from a second value. This is because when a coding unit is partitioned by a binary tree partition structure and/or a ternary tree partition structure, a coding unit smaller than the minimum size of a binary tree and/or the minimum size of a ternary tree is generated.

Alternatively, the binary tree partitioning or the ternary tree partitioning may be limited on the basis of the size of a virtual pipeline data unit (hereinafter, a pipeline buffer size). For example, when the coding unit is divided into sub-coding units which do not fit the pipeline buffer size by the binary tree partitioning or the ternary tree partitioning, the corresponding binary tree partitioning or ternary tree partitioning may be limited. The pipeline buffer size may be the size of the maximum transform block (e.g., 64×64). For example, when the pipeline buffer size is 64×64, the division below may be limited.
N×M (N and/or M is 128) Ternary tree partitioning for coding units
128×N (N<=64) Binary tree partitioning in horizontal direction for coding units
N×128 (N<=64) Binary tree partitioning in vertical direction for coding units

Alternatively, when the depth of a coding unit corresponding to a node of a multi-type tree is equal to the maximum depth of the multi-type tree, the coding unit may not be further binary-partitioned and/or ternary-partitioned. Accordingly, the multi-type tree partition indication information may not be signaled but may be deduced from a second value.

Alternatively, only when at least one of vertical direction binary tree partitioning, horizontal direction binary tree partitioning, vertical direction ternary tree partitioning, and horizontal direction ternary tree partitioning is possible for a coding unit corresponding to a node of a multi-type tree, the multi-type tree partition indication information may be signaled. Otherwise, the coding unit may not be binary-partitioned and/or ternary-partitioned. Accordingly, the multi-type tree partition indication information may not be signaled but may be deduced from a second value.

Alternatively, only when both of the vertical direction binary tree partitioning and the horizontal direction binary tree partitioning or both of the vertical direction ternary tree partitioning and the horizontal direction ternary tree partitioning are possible for a coding unit corresponding to a node of a multi-type tree, the partition direction information may be signaled. Otherwise, the partition direction information may not be signaled but may be derived from a value indicating possible partitioning directions.

Alternatively, only when both of the vertical direction binary tree partitioning and the vertical direction ternary tree partitioning or both of the horizontal direction binary tree partitioning and the horizontal direction ternary tree partitioning are possible for a coding tree corresponding to a node of a multi-type tree, the partition tree information may be signaled. Otherwise, the partition tree information may not be signaled but be deduced from a value indicating a possible partitioning tree structure.

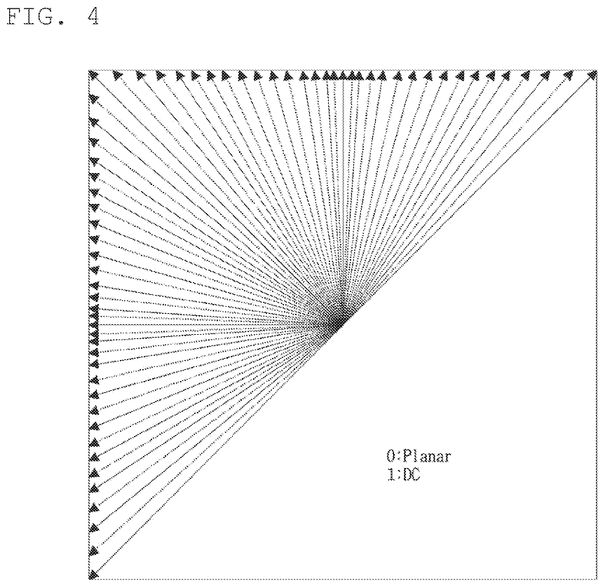

FIG. 4 is a view showing an intra-prediction process.

Arrows from center to outside in FIG. 4 may represent prediction directions of intra prediction modes.

Intra encoding and/or decoding may be performed by using a reference sample of a neighbor block of the current block. A neighbor block may be a reconstructed neighbor block. For example, intra encoding and/or decoding may be performed by using a coding parameter or a value of a reference sample included in a reconstructed neighbor block.

A prediction block may mean a block generated by performing intra prediction. A prediction block may correspond to at least one among CU, PU and TU. A unit of a prediction block may have a size of one among CU, PU and TU. A prediction block may be a square block having a size of 2×2, 4×4, 16×16, 32×32 or 64×64 etc. or may be a rectangular block having a size of 2×8, 4×8, 2×16, 4×16 and 8×16 etc.

Intra prediction may be performed according to intra prediction mode for the current block. The number of intra prediction modes which the current block may have may be a fixed value and may be a value determined differently according to an attribute of a prediction block. For example, an attribute of a prediction block may comprise a size of a prediction block and a shape of a prediction block, etc.

The number of intra-prediction modes may be fixed to N regardless of a block size. Or, the number of intra prediction modes may be 3, 5, 9, 17, 34, 35, 36, 65, or 67 etc. Alternatively, the number of intra-prediction modes may vary according to a block size or a color component type or both. For example, the number of intra prediction modes may vary according to whether the color component is a luma signal or a chroma signal. For example, as a block size becomes large, a number of intra-prediction modes may increase. Alternatively, a number of intra-prediction modes of a luma component block may be larger than a number of intra-prediction modes of a chroma component block.

An intra-prediction mode may be a non-angular mode or an angular mode. The non-angular mode may be a DC mode or a planar mode, and the angular mode may be a prediction mode having a specific direction or angle. The intra-prediction mode may be expressed by at least one of a mode number, a mode value, a mode numeral, a mode angle, and mode direction. A number of intra-prediction modes may be M, which is larger than 1, including the non-angular and the angular mode. In order to intra-predict a current block, a step of determining whether or not samples included in a reconstructed neighbor block may be used as reference samples of the current block may be performed. When a sample that is not usable as a reference sample of the current block is present, a value obtained by duplicating or performing interpolation on at least one sample value among samples included in the reconstructed neighbor block or both may be used to replace with a non-usable sample value of a sample, thus the replaced sample value is used as a reference sample of the current block.

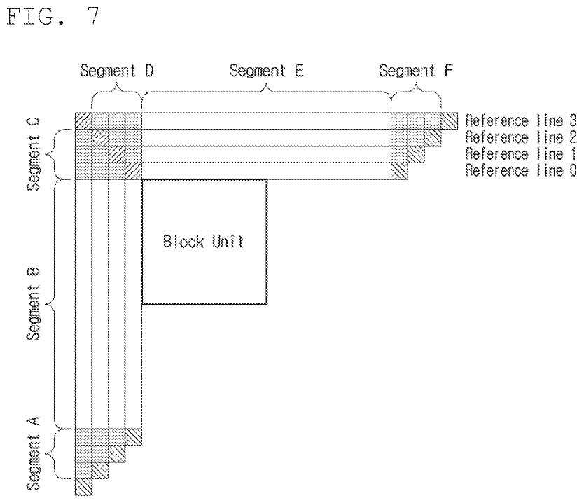

FIG. 7 is a diagram illustrating reference samples capable of being used for intra prediction.

As shown in FIG. 7, at least one of the reference sample line 0 to the reference sample line 3 may be used for intra prediction of the current block. In FIG. 7, the samples of a segment A and a segment F may be padded with the samples closest to a segment B and a segment E, respectively, instead of retrieving from the reconstructed neighboring block. Index information indicating the reference sample line to be used for intra prediction of the current block may be signaled. When the upper boundary of the current block is the boundary of the CTU, only the reference sample line 0 may be available. Therefore, in this case, the index information may not be signaled. When a reference sample line other than the reference sample line 0 is used, filtering for a prediction block, which will be described later, may not be performed.

When intra-predicting, a filter may be applied to at least one of a reference sample and a prediction sample based on an intra-prediction mode and a current block size.

In case of a planar mode, when generating a prediction block of a current block, according to a position of a prediction target sample within a prediction block, a sample value of the prediction target sample may be generated by using a weighted sum of an upper and left side reference sample of a current block, and a right upper side and left lower side reference sample of the current block. In addition, in case of a DC mode, when generating a prediction block of a current block, an average value of upper side and left side reference samples of the current block may be used. In addition, in case of an angular mode, a prediction block may be generated by using an upper side, a left side, a right upper side, and/or a left lower side reference sample of the current block. In order to generate a prediction sample value, interpolation of a real number unit may be performed.

In the case of intra prediction between color components, a prediction block for the current block of the second color component may be generated on the basis of the corresponding reconstructed block of the first color component. For example, the first color component may be a luma component, and the second color component may be a chroma component. For intra prediction between color components, the parameters of the linear model between the first color component and the second color component may be derived on the basis of the template. The template may include upper and/or left neighboring samples of the current block and upper and/or left neighboring samples of the reconstructed block of the first color component corresponding thereto. For example, the parameters of the linear model may be derived using a sample value of a first color component having a maximum value among samples in a template and a sample value of a second color component corresponding thereto, and a sample value of a first color component having a minimum value among samples in the template and a sample value of a second color component corresponding thereto. When the parameters of the linear model are derived, a corresponding reconstructed block may be applied to the linear model to generate a prediction block for the current block. According to a video format, subsampling may be performed on the neighboring samples of the reconstructed block of the first color component and the corresponding reconstructed block. For example, when one sample of the second color component corresponds to four samples of the first color component, four samples of the first color component may be sub-sampled to compute one corresponding sample. In this case, the parameter derivation of the linear model and intra prediction between color components may be performed on the basis of the corresponding sub-sampled samples. Whether or not to perform intra prediction between color components and/or the range of the template may be signaled as the intra prediction mode.

The current block may be partitioned into two or four sub-blocks in the horizontal or vertical direction. The partitioned sub-blocks may be sequentially reconstructed. That is, the intra prediction may be performed on the sub-block to generate the sub-prediction block. In addition, dequantization and/or inverse transform may be performed on the sub-blocks to generate sub-residual blocks. A reconstructed sub-block may be generated by adding the sub-prediction block to the sub-residual block. The reconstructed sub-block may be used as a reference sample for intra prediction of the sub-sub-blocks. The sub-block may be a block including a predetermined number (for example, 16) or more samples. Accordingly, for example, when the current block is an 8×4 block or a 4×8 block, the current block may be partitioned into two sub-blocks. Also, when the current block is a 4×4 block, the current block may not be partitioned into sub-blocks. When the current block has other sizes, the current block may be partitioned into four sub-blocks. Information on whether or not to perform the intra prediction based on the sub-blocks and/or the partitioning direction (horizontal or vertical) may be signaled. The intra prediction based on the sub-blocks may be limited to be performed only when reference sample line 0 is used. When the intra prediction based on the sub-block is performed, filtering for the prediction block, which will be described later, may not be performed.

The final prediction block may be generated by performing filtering on the prediction block that is intra-predicted. The filtering may be performed by applying predetermined weights to the filtering target sample, the left reference sample, the upper reference sample, and/or the upper left reference sample. The weight and/or the reference sample (range, position, etc.) used for the filtering may be determined on the basis of at least one of a block size, an intra prediction mode, and a position of the filtering target sample in the prediction block. The filtering may be performed only in the case of a predetermined intra prediction mode (e.g., DC, planar, vertical, horizontal, diagonal, and/or adjacent diagonal modes). The adjacent diagonal mode may be a mode in which k is added to or subtracted from the diagonal mode. For example, k may be a positive integer of 8 or less.

An intra-prediction mode of a current block may be entropy encoded/decoded by predicting an intra-prediction mode of a block present adjacent to the current block. When intra-prediction modes of the current block and the neighbor block are identical, information that the intra-prediction modes of the current block and the neighbor block are identical may be signaled by using predetermined flag information. In addition, indicator information of an intra-prediction mode that is identical to the intra-prediction mode of the current block among intra-prediction modes of a plurality of neighbor blocks may be signaled. When intra-prediction modes of the current block and the neighbor block are different, intra-prediction mode information of the current block may be entropy encoded/decoded by performing entropy encoding/decoding based on the intra-prediction mode of the neighbor block.

FIG. 5 is a diagram illustrating an embodiment of an inter-picture prediction process.

In FIG. 5, a rectangle may represent a picture. In FIG. 5, an arrow represents a prediction direction. Pictures may be categorized into intra pictures (I pictures), predictive pictures (P pictures), and Bi-predictive pictures (B pictures) according to the encoding type thereof.

The I picture may be encoded through intra-prediction without requiring inter-picture prediction. The P picture may be encoded through inter-picture prediction by using a reference picture that is present in one direction (i.e., forward direction or backward direction) with respect to a current block. The B picture may be encoded through inter-picture prediction by using reference pictures that are preset in two directions (i.e., forward direction and backward direction) with respect to a current block. When the inter-picture prediction is used, the encoder may perform inter-picture prediction or motion compensation and the decoder may perform the corresponding motion compensation.

Hereinbelow, an embodiment of the inter-picture prediction will be described in detail.

The inter-picture prediction or motion compensation may be performed using a reference picture and motion information.

Motion information of a current block may be derived during inter-picture prediction by each of the encoding apparatus 100 and the decoding apparatus 200. The motion information of the current block may be derived by using motion information of a reconstructed neighboring block, motion information of a collocated block (also referred to as a col block or a co-located block), and/or a block adjacent to the co-located block. The co-located block may mean a block that is located spatially at the same position as the current block, within a previously reconstructed collocated picture (also referred to as a col picture or a co-located picture). The co-located picture may be one picture among one or more reference pictures included in a reference picture list.

The derivation method of the motion information may be different depending on the prediction mode of the current block. For example, a prediction mode applied for inter prediction includes an AMVP mode, a merge mode, a skip mode, a merge mode with a motion vector difference, a subblock merge mode, a triangle partition mode, an inter-intra combination prediction mode, affine mode, and the like. Herein, the merge mode may be referred to as a motion merge mode.

For example, when the AMVP is used as the prediction mode, at least one of motion vectors of the reconstructed neighboring blocks, motion vectors of the co-located blocks, motion vectors of blocks adjacent to the co-located blocks, and a (0, 0) motion vector may be determined as motion vector candidates for the current block, and a motion vector candidate list is generated by using the emotion vector candidates. The motion vector candidate of the current block can be derived by using the generated motion vector candidate list. The motion information of the current block may be determined based on the derived motion vector candidate. The motion vectors of the collocated blocks or the motion vectors of the blocks adjacent to the collocated blocks may be referred to as temporal motion vector candidates, and the motion vectors of the reconstructed neighboring blocks may be referred to as spatial motion vector candidates.

The encoding apparatus 100 may calculate a motion vector difference (MVD) between the motion vector of the current block and the motion vector candidate and may perform entropy encoding on the motion vector difference (MVD). In addition, the encoding apparatus 100 may perform entropy encoding on a motion vector candidate index and generate a bitstream. The motion vector candidate index may indicate an optimum motion vector candidate among the motion vector candidates included in the motion vector candidate list. The decoding apparatus may perform entropy decoding on the motion vector candidate index included in the bitstream and may select a motion vector candidate of a decoding target block from among the motion vector candidates included in the motion vector candidate list by using the entropy-decoded motion vector candidate index. In addition, the decoding apparatus 200 may add the entropy-decoded MVD and the motion vector candidate extracted through the entropy decoding, thereby deriving the motion vector of the decoding target block.

Meanwhile, the coding apparatus 100 may perform entropy-coding on resolution information of the calculated MVD. The decoding apparatus 200 may adjust the resolution of the entropy-decoded MVD using the MVD resolution information.

Meanwhile, the coding apparatus 100 calculates a motion vector difference (MVD) between a motion vector and a motion vector candidate in the current block on the basis of an affine model, and performs entropy-coding on the MVD. The decoding apparatus 200 derives a motion vector on a per sub-block basis by deriving an affine control motion vector of a decoding target block through the sum of the entropy-decoded MVD and an affine control motion vector candidate.

The bitstream may include a reference picture index indicating a reference picture. The reference picture index may be entropy-encoded by the encoding apparatus 100 and then signaled as a bitstream to the decoding apparatus 200. The decoding apparatus 200 may generate a prediction block of the decoding target block based on the derived motion vector and the reference picture index information.

Another example of the method of deriving the motion information of the current may be the merge mode. The merge mode may mean a method of merging motion of a plurality of blocks. The merge mode may mean a mode of deriving the motion information of the current block from the motion information of the neighboring blocks. When the merge mode is applied, the merge candidate list may be generated using the motion information of the reconstructed neighboring blocks and/or the motion information of the collocated blocks. The motion information may include at least one of a motion vector, a reference picture index, and an inter-picture prediction indicator. The prediction indicator may indicate one-direction prediction (L0 prediction or L1 prediction) or two-direction predictions (L0 prediction and L1 prediction).

The merge candidate list may be a list of motion information stored. The motion information included in the merge candidate list may be at least one of motion information (spatial merge candidate) of a neighboring block adjacent to the current block, motion information (temporal merge candidate) of the collocated block of the current block in the reference picture, new motion information generated by a combination of the motion information exiting in the merge candidate list, motion information (history-based merge candidate) of the block that is encoded/decoded before the current block, and zero merge candidate.

The encoding apparatus 100 may generate a bitstream by performing entropy encoding on at least one of a merge flag and a merge index and may signal the bitstream to the decoding apparatus 200. The merge flag may be information indicating whether or not to perform the merge mode for each block, and the merge index may be information indicating that which neighboring block, among the neighboring blocks of the current block, is a merge target block. For example, the neighboring blocks of the current block may include a left neighboring block on the left side of the current block, an upper neighboring block disposed above the current block, and a temporal neighboring block temporally adjacent to the current block.

Meanwhile, the coding apparatus 100 performs entropy-coding on the correction information for correcting the motion vector among the motion information of the merge candidate and signals the same to the decoding apparatus 200. The decoding apparatus 200 can correct the motion vector of the merge candidate selected by the merge index on the basis of the correction information. Here, the correction information may include at least one of information on whether or not to perform the correction, correction direction information, and correction size information. As described above, the prediction mode that corrects the motion vector of the merge candidate on the basis of the signaled correction information may be referred to as a merge mode having the motion vector difference.

The skip mode may be a mode in which the motion information of the neighboring block is applied to the current block as it is. When the skip mode is applied, the encoding apparatus 100 may perform entropy encoding on information of the fact that the motion information of which block is to be used as the motion information of the current block to generate a bit stream, and may signal the bitstream to the decoding apparatus 200. The encoding apparatus 100 may not signal a syntax element regarding at least any one of the motion vector difference information, the encoding block flag, and the transform coefficient level to the decoding apparatus 200.

The subblock merge mode may mean a mode that derives the motion information in units of sub-blocks of a coding block (CU). When the subblock merge mode is applied, a subblock merge candidate list may be generated using motion information (sub-block based temporal merge candidate) of the sub-block collocated to the current sub-block in the reference image and/or an affine control point motion vector merge candidate.

The triangle partition mode may mean a mode that derives motion information by partitioning the current block into diagonal directions, derives each prediction sample using each of the derived motion information, and derives the prediction sample of the current block by weighting each of the derived prediction samples.

The inter-intra combined prediction mode may mean a mode that derives a prediction sample of the current block by weighting a prediction sample generated by inter prediction and a prediction sample generated by intra prediction.

The decoding apparatus 200 may correct the derived motion information by itself. The decoding apparatus 200 may search the predetermined region on the basis of the reference block indicated by the derived motion information and derive the motion information having the minimum SAD as the corrected motion information.

The decoding apparatus 200 may compensate a prediction sample derived via inter prediction using an optical flow.

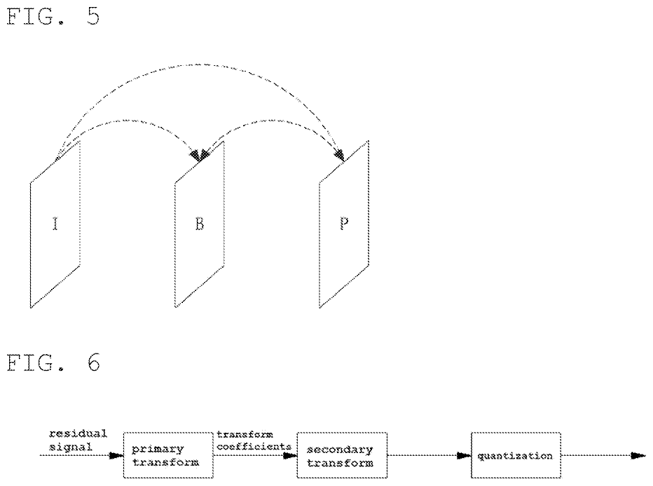

FIG. 6 is a diagram illustrating a transform and quantization process.

As illustrated in FIG. 6, a transform and/or quantization process is performed on a residual signal to generate a quantized level signal. The residual signal is a difference between an original block and a prediction block (i.e., an intra prediction block or an inter prediction block). The prediction block is a block generated through intra prediction or inter prediction. The transform may be a primary transform, a secondary transform, or both. The primary transform of the residual signal results in transform coefficients, and the secondary transform of the transform coefficients results in secondary transform coefficients.

At least one scheme selected from among various transform schemes which are preliminarily defined is used to perform the primary transform. For example, examples of the predefined transform schemes include discrete cosine transform (DCT), discrete sine transform (DST), and Karhunen-Loève transform (KLT). The transform coefficients generated through the primary transform may undergo the secondary transform. The transform schemes used for the primary transform and/or the secondary transform may be determined according to coding parameters of the current block and/or neighboring blocks of the current block. Alternatively, transform information indicating the transform scheme may be signaled. The DCT-based transform may include, for example, DCT-2, DCT-8, and the like. The DST-based transform may include, for example, DST-7.

A quantized-level signal (quantization coefficients) may be generated by performing quantization on the residual signal or a result of performing the primary transform and/or the secondary transform. The quantized level signal may be scanned according to at least one of a diagonal up-right scan, a vertical scan, and a horizontal scan, depending on an intra prediction mode of a block or a block size/shape. For example, as the coefficients are scanned in a diagonal up-right scan, the coefficients in a block form change into a one-dimensional vector form. Aside from the diagonal up-right scan, the horizontal scan of horizontally scanning a two-dimensional block form of coefficients or the vertical scan of vertically scanning a two-dimensional block form of coefficients may be used depending on the intra prediction mode and/or the size of a transform block. The scanned quantized-level coefficients may be entropy-encoded to be inserted into a bitstream.

A decoder entropy-decodes the bitstream to obtain the quantized-level coefficients. The quantized-level coefficients may be arranged in a two-dimensional block form through inverse scanning. For the inverse scanning, at least one of a diagonal up-right scan, a vertical scan, and a horizontal scan may be used.

The quantized-level coefficients may then be dequantized, then be secondary-inverse-transformed as necessary, and finally be primary-inverse-transformed as necessary to generate a reconstructed residual signal.

Inverse mapping in a dynamic range may be performed for a luma component reconstructed through intra prediction or inter prediction before in-loop filtering. The dynamic range may be divided into 16 equal pieces and the mapping function for each piece may be signaled. The mapping function may be signaled at a slice level or a tile group level. An inverse mapping function for performing the inverse mapping may be derived on the basis of the mapping function. In-loop filtering, reference picture storage, and motion compensation are performed in an inverse mapped region, and a prediction block generated through inter prediction is converted into a mapped region via mapping using the mapping function, and then used for generating the reconstructed block. However, since the intra prediction is performed in the mapped region, the prediction block generated via the intra prediction may be used for generating the reconstructed block without mapping/inverse mapping.

When the current block is a residual block of a chroma component, the residual block may be converted into an inverse mapped region by performing scaling on the chroma component of the mapped region. The availability of the scaling may be signaled at the slice level or the tile group level. The scaling may be applied only when the mapping for the luma component is available and the division of the luma component and the division of the chroma component follow the same tree structure. The scaling may be performed on the basis of an average of sample values of a luma prediction block corresponding to the color difference block. In this case, when the current block uses inter prediction, the luma prediction block may mean a mapped luma prediction block. A value necessary for the scaling may be derived by referring to a lookup table using an index of a piece to which an average of sample values of a luma prediction block belongs. Finally, by scaling the residual block using the derived value, the residual block may be switched to the inverse mapped region. Then, chroma component block restoration, intra prediction, inter prediction, in-loop filtering, and reference picture storage may be performed in the inverse mapped area.

Information indicating whether the mapping/inverse mapping of the luma component and chroma component is available may be signaled through a set of sequence parameters.

The prediction block of the current block may be generated on the basis of a block vector indicating a displacement between the current block and the reference block in the current picture. In this way, a prediction mode for generating a prediction block with reference to the current picture is referred to as an intra block copy (IBC) mode. The IBC mode may be applied to M×N (M<=64, N<=64) coding units. The IBC mode may include a skip mode, a merge mode, an AMVP mode, and the like. In the case of a skip mode or a merge mode, a merge candidate list is constructed, and the merge index is signaled so that one merge candidate may be specified. The block vector of the specified merge candidate may be used as a block vector of the current block. The merge candidate list may include at least one of a spatial candidate, a history-based candidate, a candidate based on an average of two candidates, and a zero-merge candidate. In the case of an AMVP mode, the difference block vector may be signaled. In addition, the prediction block vector may be derived from the left neighboring block and the upper neighboring block of the current block. The index on which neighboring block to use may be signaled. The prediction block in the IBC mode is included in the current CTU or the left CTU and limited to a block in the already reconstructed area. For example, a value of the block vector may be limited such that the prediction block of the current block is positioned in an area of three 64×64 blocks preceding the 64×64 block to which the current block belongs in the encoding/decoding order. By limiting the value of the block vector in this way, memory consumption and device complexity according to the IBC mode implementation may be reduced.

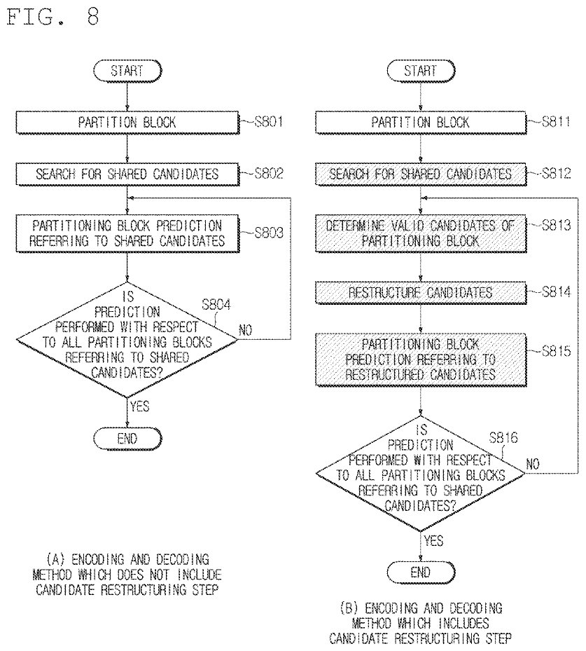

Hereinafter, an image encoding/decoding method according to an embodiment of the present invention will be described with reference to FIGS. 8 to 41.

Recently, since a broadcast service having ultra high definition (UHD) resolution (3840×216) has been expanded not only in the country but also in the world, many users are getting used to videos having ultra high resolution and ultra high definition. In addition, with development of shooting and editing technology, various video services such as panoramic videos or 360-degree videos are provided and thus the sizes of videos are gradually increasing. In line with this, many organizations are accelerating the development of next-generation video apparatuses.

MPEG (Moving Picture Experts Group) and VCEG (Video Coding Experts Group) jointly formed JCT-VC (Joint Collaborative Team on Video Coding) and completed standardization of HEVC (High Efficiency Video Coding)/H.265, which is as a next-generation moving picture codec with twice compression efficiency/performance of H.264/AVC, in 2010.

In addition, MPEG and VCEG jointly formed JVET (Joint Video Expert Team) and started standardization of VVC (Versatile Video Coding)/H.266, which is a next-generation video codec suitable for compression of various video images, on April, 2018.

As a method of improving image coding efficiency, a method of removing intra or inter redundancy has been used. Prediction using information having similarity may be used to remove intra or inter redundancy. Inter prediction may use high similarity between a current picture and a reference picture. Through inter prediction, motion information such as a pixel value and a motion vector of the current picture and a reference picture index may be predicted from the reference picture. At this time, only a difference in pixel value and motion information between the current picture to be coded/decoded and the reference picture may be coded/decoded. As the difference between the reference information used for prediction and the image information value of the currently coded/decoded region decreases, prediction accuracy may increase and thus coding efficiency may increase.

In an AMVP mode, the motion information of the current block may be coded/decoded using motion information of a neighbor block. Specifically, in the AMVP mode, the motion information of the current block may be coded/decoded using a difference between the motion information of a candidate block and the motion information of the current block.

In a merge mode, the motion information of the current block may be coded/decoded using the motion information of the neighbor block. Specifically, in the merge mode, the motion information of the candidate block may be used as the motion information of the current block. Whether to use the merge mode may be determined based on a merge mode indicator general_merge_flag.

Meanwhile, when the merge mode indicator has a first value (e.g., “1” or “true”), at least one of a regular merge mode indicator regular_merge_flag, an MMVD merge mode indicator mmvd_merge_flag, a subblock merge mode indicator merge_subblock_flag or a CIIP (Combined Inter and Intra Prediction) mode indicator ciip_flag may be obtained from a bitstream.

The motion information may have a highest percentage of the coding mode. The motion information may include information on a motion vector, a reference picture index and a reference direction and may be transmitted in block units.

In general, an image has information with high intra redundancy and a video has high inter redundancy characteristics. Accordingly, when information on the image is represented by distinguishable specific symbols, a frequency of occurrence of a symbol may be concentrated. Entrophy coding is a video coding method capable of increasing coding efficiency in consideration of such a frequency of occurrence of the symbol. Specifically, a symbol having a high frequency of occurrence is represented by a code having a small size and a symbol having a low frequency of occurrence may be represented by a code having a large size.

For more efficient video encoding/decoding, each frame of the video may be partitioned in block units. At this time, the block may mean a unit in which prediction is performed. Examples of block partitioning include a CU, a PU, a macro block, a subblock, or each partition of a triangle prediction mode (TPM) or multiple shapes prediction (MSP). Inter prediction may be performed in each partitioned block and, for more efficient inter prediction, motion information prediction may be performed by referring to specific motion information. Examples of motion information prediction may include an AMVP mode, a merge mode, etc. Here, the MSP mode may be used as the same meaning as a GPM (Geometric Partitioning Mode).

In the MSP mode, a rectangular current block is partitioned into two blocks and inter prediction is performed with respect to each subblock. When inter prediction is performed in the MSP mode, unidirectional inter prediction may be performed with respect to each subblock. At this time, the current block may be partitioned using one of 64 directions.

In the MSP mode, the prediction sample of the current block may be generated by weighted-summing a prediction sample of each subblock on boundaries of the each subblock.

The MSP mode may be performed only when a specific condition is satisfied.

For example, the MSP mode may be performed only when the slice type of the current block is a bidirectional prediction type and the size of the current block is 8×8 or more.

In addition, the MSP mode may be performed only when the merge mode indicator general_merge_flag is “1” (or “True”) and the regular merge mode indicator regular_merge_flag, the subblock merge mode indicator merge_subblock_flag and the CIIP mode indicator ciip_flag are “0” (or “False”).

In addition, the MSP mode may be performed only when the width of the current block is less than eight times the height thereof or the height of the current block is less than eight times the width thereof.

When motion information prediction is performed, a plurality of blocks may refer to the same motion information. The motion information referred to at this time may be referred to as a motion information candidate. Examples in which the plurality of blocks refers to the same motion information include a method of structuring a motion information candidate in a CU unit and sharing the motion information candidate in a PU unit or a sub-CU unit belonging to the CU, a method of structuring and sharing a motion information candidate shared in a upper block unit before partitioning blocks into the predetermined size or less, a method of structuring and sharing a motion information candidate shared in a upper block unit before partitioning in a specific block partitioning form which is triangle prediction, MSP, etc.

For example, when the current block is partitioned into two blocks through an MSP mode, each subblock may share a motion information candidate list structured in a current block unit.

When a plurality of blocks shares the same motion information candidates, each structured motion information candidate may not be suitable for prediction of the motion information of each block. According to the present invention, coding efficiency may be improved by selecting or preferentially using valid motion information candidates for each block from the shared motion information candidates. In addition, it is possible to reduce computational complexity of coding by excluding candidates having low coding efficiency for each block.

According to one embodiment of the present invention, valid candidates may be selected from among the shared motion candidates or the priority of the shared motion candidates may be changed, in order to improve coding efficiency. At this time, the process of selecting the valid candidates or changing the priority may be referred to as a candidate restructuring process.

That is, motion candidates to be used for prediction for each subblock may be selected from among a plurality of motion information candidates included in a motion information candidate list shared by a plurality of subblocks.

For example, each subblock in a current block may selectively use any one of L0 prediction direction motion information or L1 prediction direction motion information candidates in a motion information candidate list structured in the current block unit.

When motion prediction is performed using motion candidates shared by a plurality of blocks, valid candidates may be different or suitable candidate priority may be different according to each block.

When only valid candidates are selected from among the shared motion candidates and used according to each block, since the generation range of a signal indicating the candidates selected for motion prediction decreases, entropy coding efficiency may increase and coding efficiency increase. In addition, since the number of candidates used actually is reduced, a process of comparing coding efficiency during coding may be reduced and computational complex used for coding may be reduced.

When priority is given to the shared motion candidates to be suitable for each block, since a signal indicating candidates selected for motion prediction is concentrated, entropy coding efficiency may increase and coding efficiency may increase.

A candidate restructuring process according to an embodiment of the present invention may include at least one of a method of excluding repetitive use of candidates, a method of determining candidates in consideration of the spatial positions of the shared candidates or a method of determining candidates in consideration of similarity in prediction information or motion information between shared candidates.

FIG. 8 is a flowchart illustrating a case where a candidate restructuring process is not included and a case where a candidate restructuring process is included in a coding and decoding process using shared candidates according to an embodiment of the present invention.

As shown in FIG. 8(a), when a partitioned block uses shared candidates in a encoding/decoding process, each subblock may be predicted without the candidate restructuring process. In the encoding/decoding process using the shared candidates, a “block partitioning” step of partitioning a block of a region using the shared candidates may be performed (S801).

In addition, a “shared candidate search” step of searching for and restructuring shared candidates to be used in subblocks may be performed (S802). At this time, the shared candidate search step S802 may include a process of selecting candidates to be used for prediction the block.

In addition, a “partitioning block prediction” step of referring to the shared candidates in a process of predicting the partitioning block may be performed (S803). At this time, the partitioning block may mean the block partitioned in the block partitioning step S801, and the shared candidates may mean candidates searched for and structured in the shared candidate search step S802. At this time, the subblock may be used in the same meaning as a partitioned block or a partitioning block.

In addition, when prediction is performed with respect to all subblocks referring to the shared candidates (S804—true), the prediction process of blocks which currently use the shared candidates may be finished and a next encoding/decoding process may be performed. In addition, when prediction is performed with respect to some blocks referring to the shared candidates (S804—false), the “partitioning block prediction” step S803 of referring to the shared candidates may be performed.

Unlike FIG. 8(a), the encoding/decoding process using the shared candidates according to another embodiment of the present invention may include a candidate restructuring process.

As shown in FIG. 8(b), when the partitioned block uses the shared candidates in the encoding/decoding process, each subblock may be predicted through the candidate restructuring process. In the encoding/decoding process using the shared candidates, a “block partitioning” step of partitioning a block in a region using the shared candidates may be performed (S811).

For example, when the current block is in an MSP mode, the current block may be partitioned into two subblocks. At this time, a direction in which the current block is partitioned may be determined by signaled merge_gpm_partition_idx. Here, merge_gpm_partition_idx may have a value between 0 and 63. That is, merge_gpm_partition_idx may indicate a total of 64 block partitioning directions.

In addition, a “shared candidate search” step of searching for and structuring shared candidates to be used in subblocks may be performed (S812). At this time, the shared candidate search step S812 may include a process of selecting candidates to be used for prediction of the block.

Specifically, the shared candidate search step may be performed in units of blocks before partitioning. For example, when the current block is partitioned into subblocks, the shared candidates may be derived in the current block unit. Here, the shared candidates may be represented by a motion information candidate list.

At this time, the motion information candidate list may be used in the same meaning as a merge candidate list. The motion information candidate list may include inter prediction information of at least one of motion information of the spatial neighbor block of the current block, motion information of the temporal neighbor block, combined motion information or buffer based motion information.

That is, the motion information candidate list generated in the current block unit may be shared between subblocks.

In addition, a “partitioning-block valid-candidate determination” step of determining candidates more valid for a current subblock among the shared candidates searched for and structured in the shared candidate search step S812 may be performed (S813). At this time, information which may be used in the partitioning-block valid-candidate determination step S813 may be explicitly or implicitly added. In addition, a candidate search method or a candidate structuring method may be changed in the shared candidate search step S812, such that the partitioning-block valid-candidate determination step S813 is properly performed.

In addition, a candidate restructuring step may be performed (S814). At this time, the candidate restructuring step S814 may mean a step of restructuring candidates to be suitable for prediction of the current subblock according to validity determined in the partitioning-block valid-candidate determination step S813. The candidate restructuring step S814 may include a process of selecting only candidates having high validity or changing the priority of the candidates.

Specifically, when the current block is in an MSP mode, candidates used for prediction of each subblock may be selected from among the shared candidates and shared candidates may be restructured. That is, the candidates used for prediction of each subblock may be selected and the motion information candidate list may be restructured.

For example, motion information candidates used for prediction of a first subblock may be selected from the shared motion information candidate list and motion information candidates used for prediction of a second subblock may be selected from the shared motion information candidate list.

In another example, from the shared motion information candidate list, motion information candidates in a first prediction direction may be selected as motion information candidates used for prediction of a first subblock, and motion information in a second prediction direction may be selected as motion information candidates used for prediction of a second subblock, thereby restructuring the shared motion information candidate list. Here, the first prediction direction and the second prediction direction may be predefined by the encoder/decoder or may be determined by signaled information.

In addition, the “partitioning block prediction” step of referring to the shared candidates restructured in the process of predicting the partitioning block may be performed (S815). That is, inter prediction may be performed with respect to the subblock based on the restructured candidates. At this time, the partitioning block may mean the block partitioned in the block partitioning step S811. The restructured candidates may mean candidates obtained by restructuring the candidates, which are searched for and structured in the shared candidate search step S812, in the candidate restructuring step S814.

Meanwhile, index information indicating motion information used for prediction of the subblock in the restructured candidates may be signaled. That is, index information indicating motion information used for prediction of the subblock in the restructured motion information candidate list may be signaled. Here, the index information may be signaled for each subblock.

For example, the index information of the first subblock may be represented by merge_gpm_idx0 and the index information of the second subblock may be represented by merge_gpm_idx1.

Meanwhile, the index information may be used in the candidate restructuring step.

For example, when the index information of the first subblock indicates an even value (including 0), the motion information candidate list may be restructured by selecting the motion information candidate in the first prediction direction from the shared motion information candidate list. Here, the first prediction direction may be an L0 direction.

In contrast, when the index information of the first subblock indicates an odd value, the motion information candidate list may be restructured by selecting the motion information candidate in the second prediction direction from the shared motion information candidate list. Here, the second prediction direction may be an L1 direction.

In addition, when prediction is performed with respect to all subblocks referring to the shared candidates (S816—true), the prediction process of blocks which currently use the shared candidates may be finished and a next encoding/decoding process may be performed. In addition, when prediction is performed with respect to some blocks referring to the shared candidates (S816—false), the partitioning-block valid-candidate determination step S813 may be performed again with respect to a next partitioning block.

At this time, the prediction processes of FIGS. 8(a) and 8(b) may include all prediction processes in which candidates are used. For example, the prediction processes of FIGS. 8(a) and 8(b) may include at least one of intra prediction or inter prediction.

FIG. 9 is a diagram of a case where a candidate restructuring process is not included and a case where a candidate restructuring process is included in a coding and decoding process using shared candidates according to an embodiment of the present invention.

When a partitioned block uses shared candidates in the encoding/decoding process, each subblock may be predicted without the candidate restructuring process.

Referring to FIG. 9(a), the encoder/decoder according to an embodiment of the present invention may include a block partitioning unit 902, a shared candidate searching unit 904 and a predictor 905.

In the block partitioning unit 902, a current block 901 before partitioning, which is a unpartitioned block, may be partitioned, thereby generating partitioning blocks 903. At this time, prediction using shared candidates may be performed with respect to the partitioning blocks 903.

In the shared candidate searching unit 904, shared candidates, to which the partitioning blocks 903 may commonly refer in the predictor 905, nay be searched for and restructured.

In the predictor 905, prediction for encoding/decoding the partitioning blocks 903 may be performed. At this time, prediction may include all prediction processes in which the candidates are used. For example, prediction performed in the predictor 905 may include at least one of intra prediction or inter prediction. As the result of prediction in the predictor 905, prediction information 906 which may be used in the encoding/decoding process may be output.

Unlike FIG. 9(a), according to another embodiment of the present invention, a encoding/decoding process using shared candidates may include a candidate restructuring process.

For example, referring to FIG. 9(b), the encoder/decoder according to the embodiment of the present invention may further include a partitioning-block valid-candidate determination unit 915 and a candidate restructuring unit 916 in addition to a block partitioning unit 912, a shared candidate searching unit 914 and a predictor 917.

In the block partitioning unit 912, a current block 911 before partitioning, which is a unpartitioned block, may be partitioned, thereby generating partitioning blocks 913. At this time, prediction using shared candidates may be performed with respect to the partitioning blocks 913.

In the shared candidate searching unit 914, shared candidates, to which the partitioning blocks 903 may commonly refer in the predictor 905, may be searched for and structured. At this time, partitioning information indicating how the current block 911 before partitioning is partitioned may be used. Partitioning information may be received from the block partitioning unit 912 or another signal. In addition, the shared candidate searching unit 914 may include information, which may be used in the partitioning-block valid-candidate determination unit 915, in a candidate searching or structuring result.

In the partitioning-block valid-candidate determination unit 915, candidates valid for the partitioning blocks 913 may be determined from the shared candidates searched and structured in the shared candidate searching unit 914. At this time, information on the current partitioning block may be received from another partitioning block or may be referred to by a predetermined order.

In the candidate restructuring unit 916, candidates suitable for the current partitioning block may be restructured based on validity of the shared candidates determined in the partitioning-block valid-candidate determination unit 915. For example, in the candidate restructuring unit 916, more valid candidates may be selected or the priority of the candidates may be restructured.

In the predictor 917, prediction for encoding/decoding the partitioning blocks 913 may be performed. At this time, prediction may include all prediction processes in which the candidates are used. For example, prediction performed in the predictor 917 may include at least one of intra prediction or inter prediction. In addition, in the predictor 917, candidates restructured in the candidate restructuring unit 916 may be referred to in order to code/decode the current partitioning blocks 913. As the result of prediction in the predictor 917, prediction information 918 which may be used in the encoding/decoding process may be output.

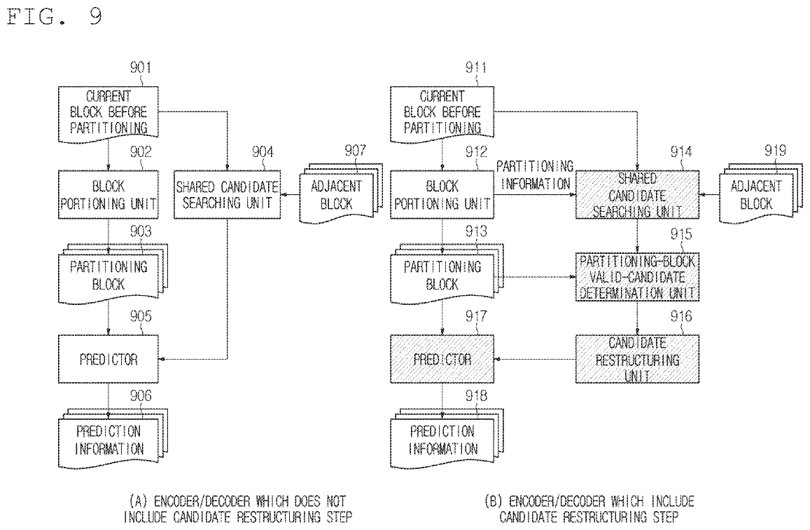

FIG. 10 is a diagram illustrating an embodiment of a method of structuring a sub candidate list from a shared candidate list.

According to an embodiment of the present invention, in selective using of only valid candidates or restructuring of the priority of the candidates for each block, a sub candidate list referred to for each block may be structured.

For example, referring to FIG. 10, sub candidate lists of Block 0 or Block 1 may be structured from the shared candidate list composed of a total of five candidates of 0, 1, 2, 3 and 4. At this time, the candidates valid for Block 0 may be 0, 1 and 4 and the candidates valid for Block 1 may be 1, 2 and 3. Accordingly, in Block 0, only 0, 1 and 4 which are the candidates valid for Block 0 may be selected, thereby structuring the sub candidate list. In addition, in Block 1, only 1, 2 and 3 which the candidates valid for Block 1 may be selected, thereby structuring the sub candidate list.

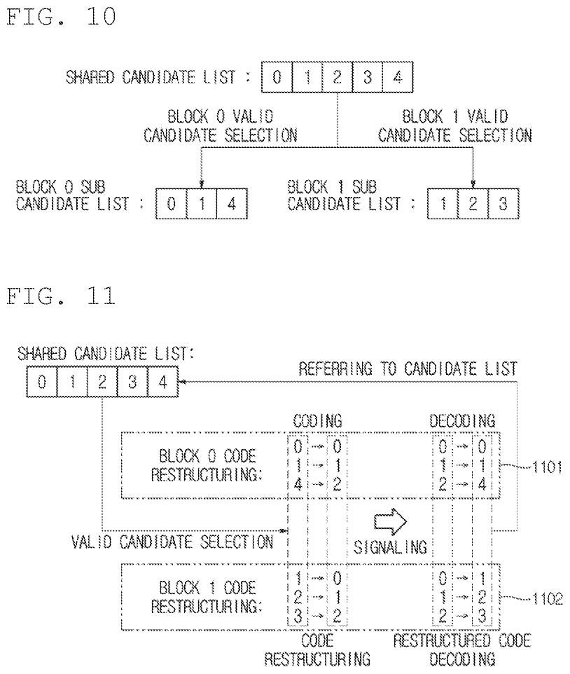

FIG. 11 is a view illustrating an embodiment of a method of restructuring the codes of candidates for each block for a candidate restructuring process.

According to an embodiment of the present invention, in selective using of only valid candidates or restructuring of the priority of the candidates for each block, the codes of the candidates may be restructured for each block.

For example, referring to FIG. 11, each of Block 0 and Block 1 may selectively use only three valid candidates from the shared candidate list composed of a total of five candidates of 0, 1, 2, 3 and 4. At this time, Block 0 may use candidates 0, 1 and 4 among the shared candidates and Block 1 may use candidates 1, 2 and 3 among the shared candidates. Here, codes 0, 1 and 2 may be allocated to the candidates selected for each block and may be signaled. That is, in the case of Block 0, codes 0, 1 and 2 may be respectively allocated to the valid candidates 0, 1 and 4 and may be coded/decoded (1101). In addition, in the case of Block 1, codes 0, 1 and 2 may be respectively to the valid candidates 1, 2 and 3 and may be coded/decoded (1102).

The method of structuring an individual sub candidate list for each block using the shared candidate described above and the method of restructuring the codes of the candidates for each block may be simultaneously used. At this time, when the same sub candidate list is structured in the encoder/decoder, the encoding/decoding process of the restructured codes of the candidates may be omitted.

In the candidate restructuring process according to an embodiment of the present invention, the method of excluding the repetitive use of the candidates may be performed.

When a plurality of blocks uses shared candidates, the blocks may have different prediction information or motion information. When the block is partitioned, signaling of a signal indicating whether partitioning is performed or a partitioning form and a signal for restructuring prediction information or motion information for each partitioned block may be separately required. Accordingly, in the case where the block has the same prediction information or motion information, coding efficiency may be high when the block is not partitioned.

Blocks are likely to have different prediction information or motion information according to the block partitioning form or method, which means that the blocks are likely to use different candidates for prediction.

Therefore, according to an embodiment of the present invention, candidates used in one of the blocks using the shared candidate may be set not to be used in the other block. In a block in which prediction is performed in a state of excluding the candidates overlapping the other blocks, the generation range of the candidates are reduced and the codes may be more efficiently signaled in entropy coding. At this time, the case where the overlapping candidates are excluded may be limited according to the partitioning form or the number of partitions of the block.

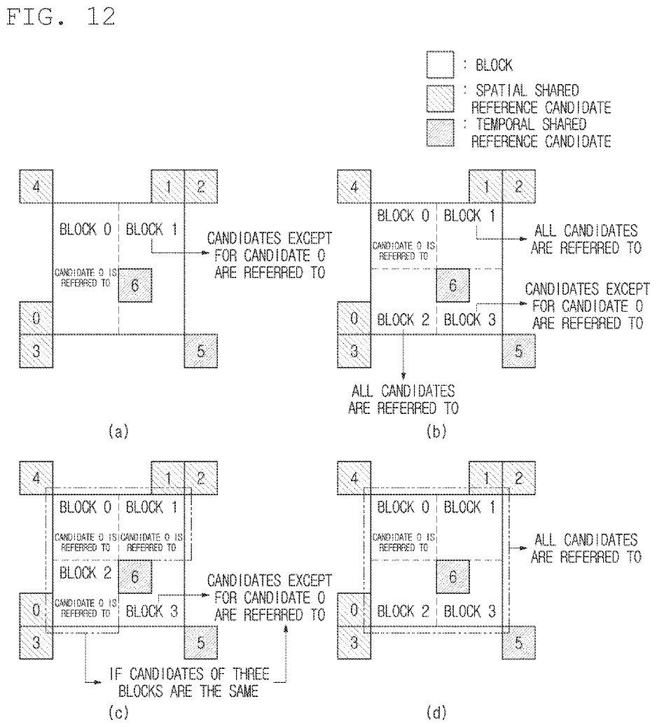

FIG. 12 is a diagram illustrating a method of excluding the repetitive use of candidates according to an embodiment of the present invention.

FIG. 12(a) shows the case where two blocks (Block 0 and Block 1) refer to the shared candidates, and FIGS. 12(b), 12(c) and 12(d) shows the case where four blocks (Block 0, Block 1, Block 2 and Block 3) refer to the shared candidates. Hereinafter, assume that decoding is performed by referring to candidate 0 in Block 1 in the description of FIG. 12.

Referring to FIG. 12(a), in Block 1, a reference candidate may be selected from among the candidates other than candidate 0 referred to in Block 0. At this time, the generation range of the candidates may be reduced, thereby increasing coding efficiency and decreasing coding complexity.

In FIGS. 12 (b), 12 (c) and 12 (d), since the four blocks are adjacent to each other, all the blocks may not refer to different candidates. That is, compared to FIG. 12(a), the candidates referred to in each block are less likely to be different from each other. At this time, overlapping candidates may be excluded in consideration of the partitioning form and the number of partitions of the block.

For example, referring to FIG. 12(b), in Blocks 1 and Block 2 which are more likely to be similar Block 0 in consideration of the partitioning form or the number of partitions of the block, the reference candidate may be selected by referring to all candidates including candidate 0 like Block 0. However, since Block 3 has a relatively low likelihood of referring to the same candidate as Block 0, a reference candidate may be selected from among the candidates except for candidate 0. At this time, the generation range of the candidate may be reduced, thereby increasing coding efficiency or coding complexity.

In addition, referring to FIG. 12(c), only when the candidates referred to in Block 0, Block 1 and Block 2 are all the same, the candidates except for the candidates referred to in Block 0, Block 1 and Block 2 may be referred to in Block 3.

In addition, as shown in FIG. 12(d), in certain cases, repetitive use of the candidates may not be excluded in consideration of the partitioning form or the number of partitions of the block. That is, in Block 1, Block 2, and Block 3, all reference candidates including candidate 0 may be selected.

In the candidate restructuring process according to an embodiment of the present invention, the method of determining the candidates in consideration of the spatial positions of the shared candidates may be performed.

Blocks having the shared candidates have different spatial positions. Accordingly, relative positions between the blocks and the candidates may be different. That is, validity of each candidate may be relatively high or low according to the positional relationships between the blocks and the candidates. Accordingly, candidates having high validity may be selectively used or candidates having high validity may be preferentially referred to according to the positional relationships between the blocks and the candidates, thereby increasing coding efficiency or decreasing coding complexity.

FIG. 13 is a diagram illustrating a method of determining candidates when validity of the shared candidates varies according to the position of the block according to an embodiment of the present invention.

FIGS. 13(a) and 13(b) show the case where each block is partitioned in a triangular shape when triangle partitioning prediction is performed. In addition, FIGS. 13(c) and 13(d) show the case where each block is partitioned in a rectangular shape. Hereinafter, in the description of FIG. 13, candidates 0, 1, 2, 3 and 4 indicate spatial candidates and candidates 5 and 6 indicate temporal candidates.

FIGS. 13(a), 13(b) and 13(c) show the case where the shared candidates are referred to in two blocks (Block A and Block B).

Referring to FIG. 13(a), Block A is adjacent to all spatial candidates 0, 1, 2, 3 and 4 and Block B is not adjacent to spatial candidate 4. At this time, candidate 4 may have lower prediction precision and lower candidate validity than the other spatial candidates in Block 4. Accordingly, when prediction is performed in Block B, candidate 4 may not be referred to or the priority of candidate 4 may be set to be low.

When candidate 4 is not referred to, the range of the candidates selectable in Block B is reduced by one, thereby increasing signaling efficiency. When the process of examining and comparing the prediction efficiency of candidate 4 during coding may be omitted, thereby decreasing coding complexity. In addition, when the priority of candidate 4 is set to be low and the candidate number is set to be increased, candidates having higher possibility may be allocated a candidate number having higher priority, thereby increasing signaling efficiency.

FIG. 13(b) shows an example of a block partitioned in a diagonal line different from that of FIG. 13(a). Referring to FIG. 13(b), Block A is adjacent to candidates 0, 3 and 4 located at the left side and Block B is adjacent to spatial candidates 1, 2 and 4 located at the top. That is, candidates 0, 3 and 4 are more likely to be referred to in Block A and candidates 1, 2 and 4 are more likely to be referred to in Block B compared to the other spatial candidates. Accordingly, in Block A, only candidates 0, 3 and 4 of the spatial candidates may be used or the priority of candidates 0, 3 and 4 may be set to be higher than that of the other spatial candidates. In addition, in Block B, only candidates 1, 2 and 4 of the spatial candidates may be used or the priority of candidates 1, 2 and 4 may be set to be higher than that of the other spatial candidates.

Referring to FIG. 13(c), Block A is adjacent to candidates 0, 3 and 4 located at the left side and Block B is adjacent to spatial candidates 1 and 2 located at the top and temporal candidates 5 and 6. Accordingly, in Block A, only candidates 0, 3 and 4 may be used or the priority of candidates 0, 3 and 4 may be set to be higher than that of the other spatial candidates. In addition, in Block B, only candidates 1, 2, 5 and 6 may be used or the priority of candidates 1, 2, 5 and 6 may be set to be higher than that of the other candidates.

FIG. 13(d) shows the case where the shared candidates are referred to in three blocks (Block A, Block B and Block C).

Referring to FIG. 13(d), Block A is adjacent to spatial candidates 1, 2 and 4 located at the top, Block B is adjacent to spatial candidates 0 and 3 located at the bottom left side and temporal candidate 6, and Block C is adjacent to temporal candidates 5 and 6 located at the bottom right side and the center. Accordingly, in Block A, only candidates 1, 2 and 4 may be used or the priority of candidates 1, 2 and 4 may be set to be high and, in Block B, only candidates 0, 3 and 6 may be used or the priority of candidates 0, 3 and 6 may be set to be high.

At this time, Block C may have only candidates 5 and 6 as adjacent candidates, but the temporal candidates may have lower prediction efficiency than the spatial candidates. Accordingly, in Block C, all candidates may be referred to. Alternatively, in Block C, as compared to the other spatial candidates, relatively adjacent spatial candidates, such as candidates 0 and 1, may be partially and selectively referred to and the priority thereof may be set to be high.

In the candidate restructuring process according to an embodiment of the present invention, the candidates may be determined in consideration of similarity in prediction information or motion information between the shared candidates.

Among the shared candidates, there are same or similar candidates. At this time, as an example of determining similar candidates, there is a method of determining similar candidates when a difference between motion vectors is within a predetermined threshold. Here, the threshold may be a value preset in the encoder/decoder or may be information determined by the encoder and signaled to the decoder. When the same or similar candidates are present in the shared candidates, valid candidates may be selected or the priority of the candidates may be set in consideration of the positions and distributions of the candidates along with the positions of the current partitioning blocks.

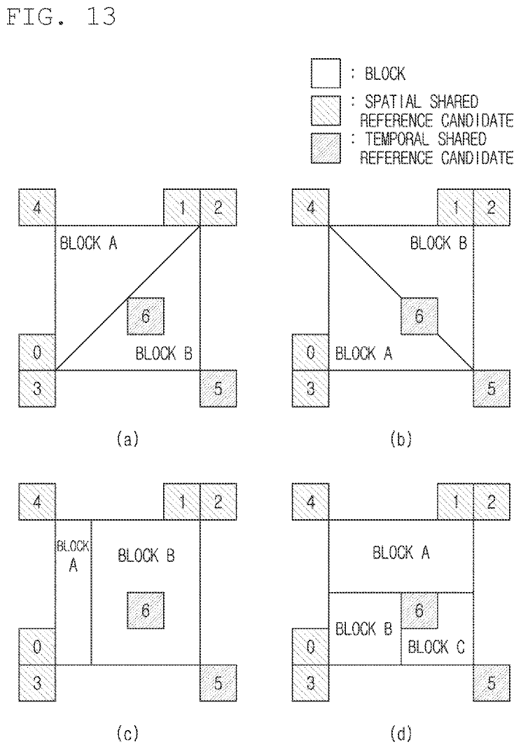

FIG. 14 is a diagram illustrating a method of selecting valid candidates in each block when candidates having the same motion information are present in shared candidates, according to an embodiment of the present invention.

FIG. 14 shows the case where a block is partitioned into four blocks (Block A, Block B, Block C, and Block D) and each of the partitioned blocks has the shared candidates.

Referring to FIG. 14(a), candidates 0, 3 and 4 may have the same prediction information or motion information. At this time, candidates 0, 3 and 4 may be combined into one candidate. Candidates 0, 3 and 4 having the same prediction information or motion information may mean that the same motion occurs over a relatively wide region in a region adjacent to the left of the current block. In addition, the blocks (e.g., Block A and Block C) located on the left side of each partitioned block are likely to have the same prediction information or motion information as candidates 0, 3 and 4. Accordingly, in Block A and Block C, candidates 0, 3 and 4 may be determined as valid candidates and may be preferentially used.

At this time, since Block B and Block D are likely to have motion different from that of Block A and Block C, candidates 0, 3 and 4 may be determined as invalid candidates or the priority of candidates 0, 3 and 4 may be set to be low, in Blocks B and D.

Referring to FIG. 14(b), candidates 1 and 4 may have the same prediction information or motion information. At this time, candidates 1 and 4 may be combined into one candidate. Candidates 1 and 4 having the same prediction information or motion information may mean that the same motion occurs over a relatively wide region in a region adjacent to the top of the current block. In addition, the blocks (e.g., Block A and Block B) located at the top of each partitioned block are likely to have the same prediction information or motion information as candidates 1 and 4. Accordingly, in Block A and Block B, candidates 1 and 4 may be determined as valid candidates and preferentially used.

At this time, since Block C and Block D are likely to have motion different from that of Block A and Block B, candidates 1 and 4 may be determined as invalid candidates and the priority of candidates 1 and 4 may be set to be low, in Blocks C and D.

Referring to FIG. 14(c), candidates 0, 1, 3 and 4 may have the same prediction information or motion information. At this time, candidates 0, 1, 3 and 4 may be combined into one candidate. Candidates 0, 1, 3 and 4 having the same prediction information or motion information may mean that Blocks A, B and C are likely to have the same motion and have the same motion as candidates 0, 1, 3 and 4. Accordingly, candidates 0, 1, 3 and 4 may be determined as valid candidates and preferentially used, in Blocks A, B and C.

At this time, since Block D is likely to have motion different from that of Blocks A, B and C, candidates 0, 1, 3 and 4 may be determined as an invalid candidate or the priority of candidates 0, 1, 3 and 4 may be set to be low in Block D.

Referring to FIG. 14(d), candidates 0, 1, 2 and 3 may have the same prediction information or motion information. At this time, candidates 0, 1, 2 and 3 may be combined into one candidate. Candidates 0, 1, 2 and 3 having the same prediction information or motion information may mean that Blocks B and C are likely to have the same motion and are likely to have the same motion as candidates 0, 1, 2 and 3. Accordingly, candidates 0, 1, 2 and 3 may be determined as valid candidates and preferentially used in Blocks B and C.

At this time, since Blocks A and D are likely to have motion different from that of Blocks B and C, candidates 0, 1, 2 and 3 may be determined as invalid candidates or the priority of candidates 0, 1, 2 and 3 may be set to be low, in Blocks A and B.

In the encoding/decoding process using the shared candidates, the partitioning form or the number of partitions of the blocks having the shared candidates may be predicted through the positional relationship between the candidates having the same prediction information or motion information among the prediction information or motion information of the shared candidates. When the partitioning form or the number of partitions of the blocks is predicted through the positional relationship between the candidates having the same prediction information or motion information among the shared candidates, the process of searching for optimal coding may be shortened by preferentially examining partitioning of the predicted block before the other partitioning form or coding efficiency may be increased by predicting the code of the block partitioning form.

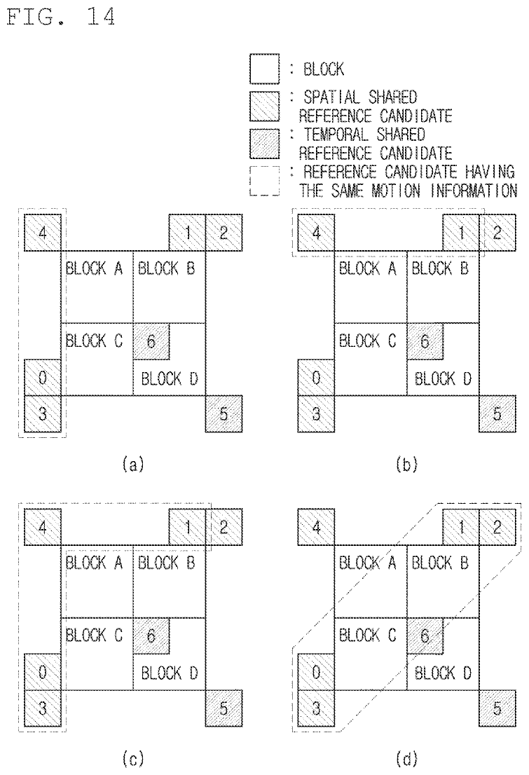

FIG. 15 is a diagram illustrating a method of predicting block partitioning by using candidates having the same motion information among shared candidates according to an embodiment of the present invention.

Referring to FIG. 15(a), candidates 0, 3 and 4 may have the same prediction information or motion information. At this time, candidates 0, 3 and 4 may be combined into one candidate. Candidates 0, 3 and 4 having the same prediction information or motion information may mean that the same motion occurs over a relatively wide region in a region adjacent to the left of the current block. In addition, the blocks located on the left side of each partitioned block are likely to have the same prediction information or motion information as candidates 0, 3 and 4.

Accordingly, since it is easy to have different motion information in the left region and the right region of the block before partitioning, and the left region is likely to have the same motion information, the block is likely to be partitioned into left and right regions.

Referring to FIG. 15(b), candidates 1 and 4 may have the same prediction information or motion information. At this time, candidates 1 and 4 may be combined into one candidate. Candidates 1 and 4 having the same prediction information or motion information may mean that the same motion occurs over a relatively wide region in a region adjacent to the top of the current block. In addition, the blocks located at the top of each partitioned block are likely to have the same prediction information or motion information as candidates 1 and 4.

Accordingly, since it is easy to have different motion information in the top region and the bottom region of the block before partitioning, and the top region is likely to have the same motion information, the block is likely to be partitioned into upper and bottom regions.

Referring to FIG. 15(c), candidates 0, 1, 3 and 4 may have the same prediction information or motion information. At this time, candidates 0, 1, 3 and 4 may be combined into one candidate. Candidates 0, 1, 3 and 4 having the same prediction information or motion information may mean that the same motion occurs over a relatively wide region in a region adjacent to the top and left of the current block. In addition, the blocks located on the top and left of each partitioned block are likely to have the same prediction information or motion information as candidates 0, 1, 3 and 4.

Accordingly, since it is easy to have different motion information in the top and left regions and the right and bottom regions of the block before partitioning, and the upper and left regions are likely to have the same motion information, the block is likely to be partitioned into a bottom right region and the other region.

Referring to FIG. 15(d), candidates 0, 1 and 4 may have the same prediction information or motion information. At this time, candidates 0, 1 and 4 may be combined into one candidate. Candidates 0, 1 and 4 having the same prediction information or motion information may mean that the same motion occurs over a relatively wide region in a region adjacent to the top and left of the current block. In addition, the blocks located on the top and left of each partitioned block are likely to have the same prediction information or motion information as candidates 0, 1 and 4.

Accordingly, since it is easy to have different motion information in the top and left regions and the right and bottom regions of the block before partitioning. In addition, since the top and left regions are likely to have the same motion information, the block is likely to be diagonally partitioned into the top left region and the bottom right region, as shown in FIG. 15(d).

According to an embodiment of the present invention, whether to use the shared candidate restructuring method may be signaled in each unit or some units. At this time, when whether to use the shared candidate restructuring method is predefined or derived from other information, signaling may be omitted.

When the shared candidate restructuring method is used, a signal referring to the restructured candidates may be transmitted and received. The signal referring to the restructured candidates may be included in a signal referring to existing shared candidates or may replace a signal referring to existing shared candidates.

Tables 1, 2 and 3 show embodiments of a method of signaling whether to use shared candidate restructuring.

Table 1 shows an example of a case where whether to use shared candidate restructuring is determined in units of sequence parameter sets (SPSs).

TABLE 1

| | Descriptor [symbol] |
|---|---|
| seq_parameter_set_rbsp() { [symbol] | ue (v) [symbol] |
| sps_seq_parameter_set_id [symbol] | [symbol] |
| ... [symbol] | [symbol] |
| if(SHARED_CANDIDATE_ENABLE) { [symbol] | [symbol] |
| shared_candidate_restructure_enable_flag [symbol] | u (1) [symbol] |
| } [symbol] | [symbol] |
| ... [symbol] | [symbol] |
| } [symbol] | [symbol] |

Table 2 shows an example of a case where whether to use shared candidate restructuring is determined in units of picture parameter sets (PPSs).

TABLE 2

| | Descriptor [symbol] |
|---|---|
| pic_parameter_set_rbsp() { [symbol] | ue (v) [symbol] |
| pps_pic_parameter_set_id [symbol] | ue (v) [symbol] |
| pps_seq_parameter_set_id [symbol] | [symbol] |
| ... [symbol] | [symbol] |
| if(SHARED_CANDIDATE_ENABLE) { [symbol] | [symbol] |
| shared_candidate_restructure_enable_flag [symbol] | u (1) [symbol] |
| } [symbol] | [symbol] |
| ... [symbol] | [symbol] |
| } [symbol] | [symbol] |

Table 3 shows an example of a case where whether to use shared candidate restructuring is determined in units of tile group headers.

TABLE 3

| | Descriptor [symbol] |
|---|---|
| tile_group_header() { [symbol] | ue (v) [symbol] |
| tile_group_pic_parameter_set_id [symbol] | [symbol] |
| ... [symbol] | [symbol] |
| if(SHARED_CANDIDATE_ENABLE) { [symbol] | [symbol] |
| shared_candidate_restructure_enable_flag [symbol] | u (1) [symbol] |
| } [symbol] | [symbol] |
| ... [symbol] | [symbol] |
| } [symbol] | [symbol] |

In Tables 1 to 3, SHARED_CANDIDATE_ENABLE indicates whether shared candidates are available and may have a specific value. For example, the shared candidates may be available when SHARED_CANDIDATE_ENABLE is “1” (or “true”), and may not be available when SHARED_CANDIDATE_ENABLE is “0” (or “false”). However, the present invention is not limited thereto and “0” may mean “true” and “1” may mean “false”. SHARED_CANDIDATE_ENABLE may be explicitly signaled or may be used without separate signaling according to a predefined usage method. In addition, when SHARED_CANDIDATE_ENABLE always has the same value, a conditional statement for checking the value of SHARED_CANDIDATE_ENABLE may be omitted.

At this time, SHARED_CANDIDATE_ENABLE may be “true” when at least one of all modes using the shared candidates in the prediction mode such as triangle partitioning prediction or MSP.

When SHARED_CANDIDATE_ENABLE is “true”, shared_candidate_restructure_enable_flag may be signaled. In contrast, when SHARED_CANDIDATE_ENABLE is “false”, shared_candidate_restructure_enable_flag may be defined as being signaled.

shared_candidate_restructure_enable_flag may be information for determining whether to use the method of restructuring the shared candidates in the transmitted units (e.g., SPS, PPS, Tile group header, etc.).

shared_candidate_restructure_enable_flag may have a specific value. For example, shared_candidate_restructure_enable_flag may have a value of “1” (or “true”) or “0” (or “false”). However, the present invention is not limited thereto and “0” may mean “true” and “1” may mean “false”. At this time, when shared_candidate_restructure_enable_flag is “true”, the method of restructuring the shared candidates may be used in the corresponding unit, and, when shared_candidate_restructure_enable_flag is “false”, the method of restructuring the shared candidates may not be used in the corresponding unit.

In addition, when whether to use the method of restructuring the shared candidates is determined in advance, signaling of shared_candidate_restructure_enable_flag may be omitted.

Table 4 shows the example of the case where signaling of whether to restructure the shared candidates in the coding unit syntax unit is used.

TABLE 4

| | Descriptor [symbol] |
|---|---|
| coding_unit( x0, y0, cbWidth, cbHeight, isInShareRegion ) { [symbol] | [symbol] |
| if(isInShareRegion) { [symbol] | [symbol] |
| ... [symbol] | [symbol] |
| if( shared_candidate_restructure_enable_flag ) { [symbol] | [symbol] |
| cu_shared_candidate_restructure_enable_flag [symbol] | u (1) [symbol] |
| } [symbol] | [symbol] |
| ... [symbol] | [symbol] |
| } [symbol] | [symbol] |
| ... [symbol] | [symbol] |
| if( !isInShareRegion && USE_SHARED_CANDIDATE_MODE ) { [symbol] | [symbol] |
| if( shared_candidate_restructure_enable_flag ) { [symbol] | [symbol] |
| cu_shared_candidate_restructure_enable_flag [symbol] | u (1) [symbol] |
| } [symbol] | [symbol] |
| } [symbol] | [symbol] |
| ... [symbol] | [symbol] |
| } [symbol] | [symbol] |

Referring to Table 4, cu_shared_candidate_restructure_enable_flag may be information for determining whether to use restructuring of the shared candidates in each CU. At this time, cu_shared_candidate_restructure_enable_flag may be signaled when shared_candidate_restructure_enable_flag indicating whether to use restructuring of the shared candidate in a higher unit is “true”.

In contrast, when shared_candidate_restructure_enable_flag is “false”, cu_shared_candidate_restructure_enable_flag may be signaled.

If the value of shared_candidate_restructure_enable_flag is not present as whether to use restructuring of the shared candidates is determined in advance, cu_shared_candidate_restructure_enable_flag may be signaled depending on whether to use restructuring of the shared candidates in a high unit determined in advance.

In the coding unit syntax, cu_shared_candidate_restructure_enable_flag may be signaled when the shared candidates are used in the current CU. At this time, isInshareRegion may be information indicating whether the current CU uses the shared candidates. That is, when isInShareRegion is “true”, cu_shared_candidate_restructure_enable_flag may be signaled.

However, even when isInShareRegion is “false”, the candidates shared by triangle partitioning prediction and MSP may be used.

For example, when a specific mode (e.g., triangle partitioning prediction, MSP, etc.) uses the shared candidates and encoding/decoding is performed in one or more of the corresponding modes in the current CU, the value of USE_SHARED_CANDIDATE_MODE may be “true”. At this time, when USE_SHARED_CANDIDATE_MODE is “true”, even if isInShareRegion is “false”, cu_shared_candidate_restructure_enable_flag may be signaled.

In contrast, when the current CU does not use the mode using the shared candidates, the value of USE_SHARED_CANDIDATE_MODE may be “false”. At this time, when both USE_SHARED_CANDIDATE_MODE and isInShareRegion are “false”, cu_shared_candidate_restructure_enable_flag may not be signaled.

When cu_shared_candidate_restructure_enable_flag is “true”, a signal indicating the referred prediction candidates may be signaled. At this time, the signal indicating the referred prediction candidates may be a signal changed by a restructured candidate structure.

When whether to use restructuring of the shared candidates is equally specified in the encoder/decoder in advance or restructuring of the shared candidates is specified not to be used in a specific mode, signaling of cu_shared_candidate_restructure_enable_flag may be omitted.

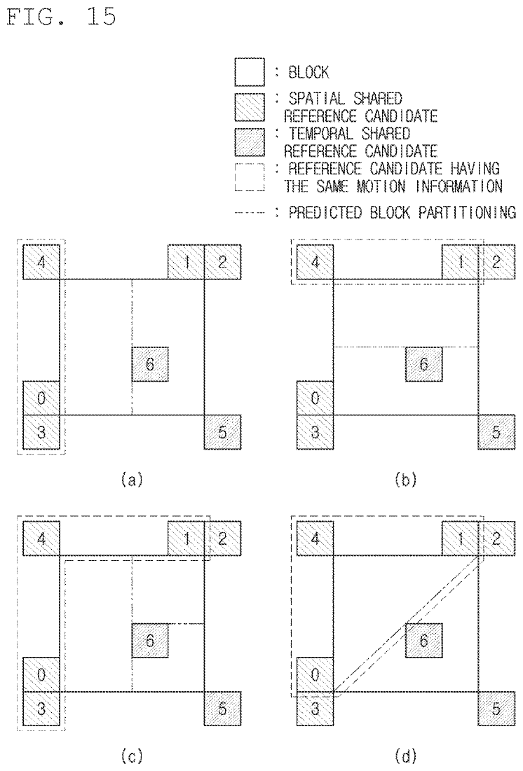

FIG. 16 is a view illustrating an image decoding method according to an embodiment of the present invention.

Referring to FIG. 16, the image decoder may structure the motion information candidate list of a current block (S1601).

The motion information candidate list may include at least one of motion information of a spatial neighbor block, motion information of a temporal neighbor block, combined motion information or zero motion information.

In addition, a first motion information candidate used for prediction of a first subblock in the current block may be selected from the motion information candidate list (S1602).

The first motion information candidate may be any one of the candidates in a first prediction direction in the motion information candidate list.

In addition, a second motion information candidate used for prediction of a second subblock in the current block may be selected from the motion information candidate list (S1603).

The second motion information candidate may be any one of the candidates in the second prediction direction in the motion information candidate list.

In addition, the prediction sample of the first subblock may be generated by performing inter prediction with respect to the first subblock based on the first motion information candidate (S1604).

In addition, the prediction sample of the second subblock may be generated by performing inter prediction with respect to the second subblock based on the second motion information candidate (S1605).

The image decoder may acquire a first index for the first subblock and a second index for the second subblock from a bitstream.

The first index may be used to select the first motion information candidate from among the candidates in the first prediction direction.

In addition, the second index may be used to select the second motion information candidate from among the candidates in the second prediction direction.

The first index and the second index may be different.

The first prediction direction may be determined based on the first index.

In addition, the second prediction direction may be determined based on the second index.

When the first index is an even number, the first prediction direction may be determined as an L0 direction.

In addition, when the second index is an even number, the second prediction direction may be determined as an L0 direction.

When the first index is an odd number, the first prediction direction may be determined as an L1 direction.

In addition, when the second index is an odd number, the second prediction direction may be determined as an L1 direction.

The image decoder may acquire an index for the partitioning direction of the current block from the bitstream.

The number of partitioning directions of the current block may be 64.

The prediction sample of the first subblock and the prediction sample of the second subblock may be weighted-summed based on boundaries of the first subblock and the second subblock, thereby predicting the current block.

FIG. 17 is a view illustrating an image coding method according to an embodiment of the present invention.

Referring to FIG. 17, the image encoder may structure the motion information candidate list for the current block (S1701).

The motion information candidate list may include at least one of the motion information of the spatial neighbor block, the motion information of the temporal neighbor block, the combined motion information or the zero motion information.

In addition, the first motion information candidate used for prediction of the first subblock in the current block may be selected from the motion information candidate list (S1702).

The first motion information candidate may be any one of the candidates in the first prediction direction in the motion information candidate list.

In addition, the second motion information candidate used for prediction of the second subblock in the current block may be selected from the motion information candidate list (31703).

The second motion information candidate may be any one of the candidates in the second prediction direction in the motion information candidate list.

The image encoder may code the first index for the first subblock and the second index for the second subblock.

The first index may be used to select the first motion information candidate from among the candidates in the first prediction direction.

In addition, the second index may be used to select the second motion information candidate from among the candidates in the second prediction direction.

The first index and the second index may be different.

The first prediction direction may be determined based on the first index.

In addition, the second prediction direction may be determined based on the second index.

When the first index is an even number, the first prediction direction may be determined as an L0 direction.

In addition, when the second index is an even number, the second prediction direction may be determined as an L0 direction.

When the first index is an odd number, the first prediction direction may be determined as an L1 direction.

In addition, when the second index is an odd number, the second prediction direction may be determined as an L1 direction.

The image encoder may code an index for the partitioning direction of the current block.

The number of partitioning directions of the current block may be 64.

The bitstream generated by the image coding method of the present invention may be temporarily stored in a non-transitory computer-readable recording medium and may be coded by the above-described image coding method.

Specifically, in a non-transitory computer-readable recording medium for storing a bitstream generated by a method of coding an image, the method includes structuring a motion information candidate list of a current block, selecting a first motion information candidate used for prediction of a first subblock in the current block from the motion information candidate list, and selecting a second motion information candidate used for prediction of a second subblock in the current block from the motion information candidate list. The first motion information candidate is any one of candidates in a first prediction direction in the motion information candidate list, and the second motion information candidate is any one of candidates in a second prediction direction in the motion information candidate list.

In image compression technology, coding is performed in consideration of the statistical characteristics of an input image. The image compression technology may include predictive coding technology for removing temporal and spatial redundancy, transform coding technology based on cognitive vision, quantization technology, entropy coding technology and filter technology for improving prediction efficiency. At this time, the predictive coding technology may include intra prediction and inter prediction. The image compression technology uses the principle of reducing the size of image data by removing the overlapping signal from the image signal.

The encoder may receive information in the picture unit from an original video image for coding. At this time, the received original video image may be referred to as a coding picture.

Intra prediction refers to technology for predicting information using spatial similarity between internal pixels of a coding picture. In intra prediction, overlapping information in the image frame may be used for prediction of the image signal, in order to remove the image signal overlapping in the space.

Inter prediction refers to technology for predicting information using temporal similarity between a coding picture and a reference picture previously decoded at a previous time of a current time. In inter prediction, information overlapping between image frames may be used for prediction of the image signal in order to remove the image signal overlapping in the time.

In image compression, prediction is performed by partitioning an image screen in block units having a predetermined size, for error robustness and efficient memory usage. At this time, a block in which prediction is currently being performed in a video compression and reconstruction process is referred to as a current block. In prediction of the image signal in the image compression technology, the pixel of a block adjacent to the image signal of the current block is used or an image signal decoded before encoding/decoding of the current block is used, such that the pixel of the current block is predicted through various methods. In the image compression process, since a region having an image signal which is exactly the same as the current block in terms of time and space may not be present, a residual signal corresponding to prediction error may occur in the image signal prediction. The encoder transmits, to the decoder, the prediction information of a most efficient prediction method and a residual signal generated after prediction, and the decoder receives the prediction method and the residual signal from the encoder and perform decoding of the image signal. Accordingly, it is advantageous in terms of image compression efficiency to minimize information on the residual signal transmitted to the decoder and the prediction information transmitted to the decoder in the compression process of the image signal.

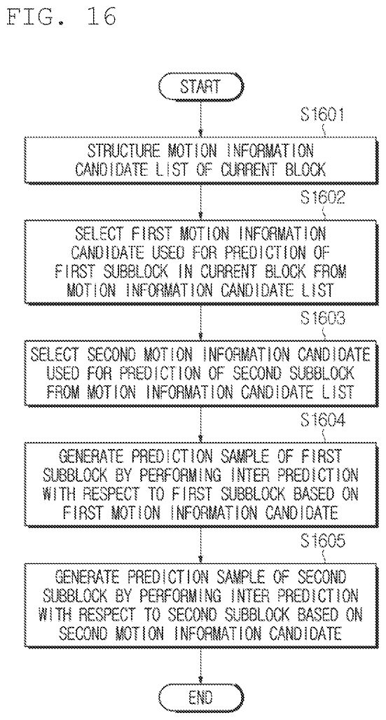

FIG. 18 is a view illustrating an embodiment of an intra prediction mode used in image compression technology.

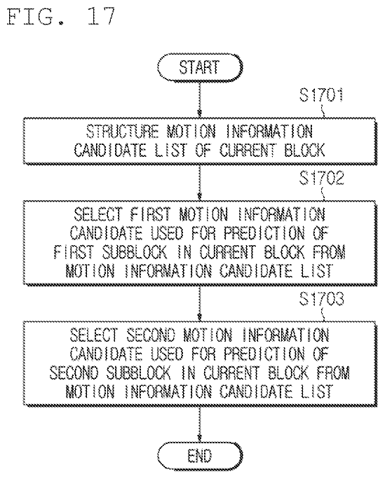

FIG. 19 is a view illustrating an embodiment of a prediction method according to a directional intra prediction mode.

In intra prediction of the image compression technology, the pixel of the neighbor block adjacent to the current block may be used to perform prediction of the image signal for the pixel of the current block. The encoder may try many prediction methods from the pixel of the neighbor block to calculate coding efficiency and select a coding method having optimal coding efficiency, in order to minimize the residual signal in intra prediction.

In intra prediction of the image compression technology, as shown in FIG. 18, DC prediction, PLANAR prediction and directional intra prediction may be used. In addition, as shown in FIG. 19, the image signal of the pixel of the current block may be predicted from the pixel of the neighbor block.

In the case of DC prediction, an average of the neighbor pixels of the current block may be used. In addition, in the case of PLANAR prediction, a series of computations may be performed with respect to the neighbor pixel value of the current block, thereby predicting the image signal of the pixel of the current block.

Information on the intra prediction mode of FIG. 18 may be transmitted from the encoder to the decoder, such that the decoder may perform decoding according to the prediction method determined by the encoder. Since information on the intra prediction mode transmitted from the encoder to the decoder is included in image compression data, it is important to reduce the size of the information on the intra prediction mode transmitted from the encoder to the decoder in image compression.

Accordingly, the below-described embodiment of the present invention relates to a method of increasing image compression efficiency by reducing the size of intra prediction mode information.

When intra prediction is performed in image compression, an image signal obtained by compressing a residual signal which is prediction error of intra prediction and an intra prediction mode may be transmitted from the encoder to the decoder. As the intra prediction mode has finer directionality, intra prediction may be more accurately performed, thereby reducing the residual signal. However, as the intra prediction mode has finer directionality, the number of types of intra prediction modes increases, thereby increasing the amount of data for representing the intra prediction mode. Accordingly, in image compression, the number of intra prediction modes having optimal efficiency experimentally is used in a trade-off relationship between the amount of data of the residual signal and the amount of data for representing the intra prediction mode.

In order to represent N values in image compression, a digital signal of ┌log N┐ bits or more is required. Here, ┌log N┐ may mean the smallest integer among integers greater than or equal to log N. For example, if N is 64, a digital signal of at least 6 bits is required to represent 64 values. In addition, if N is 30, a digital signal of at least 5 bits is required to represent 30 values.

As a method of decreasing the amount of data for representing the intra prediction mode in intra prediction of image compression, MPM (Most Probable Mode) candidates composed of the intra prediction mode of blocks located around the current block may be structured. At this time, when the same intra prediction mode as the current block is present in the structured MPM candidates, the corresponding mode may be transmitted through an index.

The MPM candidates may be structured through a series of computations from the intra prediction mode of the neighbor block of the current block. In addition, when the intra prediction mode of the available neighbor block is not present, the MPM candidates may be structured in a predetermined intra prediction mode. In general, the number of candidates of the MPM candidate list is structured to be less than the number of types of intra prediction modes, high compression efficiency may be shown in that fewer representation bits than data for representing the number of types are required.

When the same mode as the intra prediction mode of the current block is present in the MPM candidates, instead of the intra prediction mode, an MPM index may be transmitted to the decoder.

However, when the same mode as the intra prediction mode of the current block is not present in the MPM candidates, the intra prediction mode of the current block may be classified as a non-MPM intra prediction mode. At this time, the intra prediction mode may be compressed using FLC (Fixed Length Coding), Truncation Coding, etc. In general, the compression technology for the non-MPM intra prediction mode has lower compression efficiency than a method of transmitting an MPM index. Accordingly, as MPM selectivity increases, image compression efficiency may increase.

As the intra prediction mode is subdivided, the types of intra prediction modes may be diversified. Accordingly, as the intra prediction mode is subdivided, the probability that the intra prediction mode of the current block and the intra prediction mode of the neighbor block are the same may be reduced. In the image compression technology, since the length of the MPM list is less than the number of types of intra prediction modes and the MPM is structured by a length determined between the encoder and the decoder, it is less likely that the same prediction mode as the prediction mode of the current block is present in the MPM candidates as the intra prediction mode is diversified. That is, as the intra prediction mode is subdivided, MPM selectivity may decrease.

As the size of the current block decreases, the residual signal generated due to the error of intra prediction may be reduced. This means that compression efficiency capable of being obtained by decreasing data for representing the intra prediction mode due to the less subdivided intra prediction mode may be higher than compression efficiency caused by reduction of the residual signal due to increase in accuracy of the intra prediction mode due to the subdivided intra prediction mode. As the number of types of intra prediction modes decreases, accuracy of intra prediction decreases and the residual signal may relatively increase. In contrast, as the number of types of intra prediction decreases, the size of the data required to represent intra prediction may decrease. In addition, as the number of types of intra prediction mode decreases, MPM selectivity may increase and the amount of data required for non-MPM compression may decrease, thereby greatly reducing the amount of data for representing the intra prediction mode. That is, in a small block, as the number of types of intra prediction modes decreases, compression efficiency may increase.

The small block described in this specification may mean a block which does not exceed a threshold of the width and/or height of a block predefined in the encoder/decoder. In addition, the threshold may be dynamically changed according to the size of an image or the size and partitioning depth of a maximum block in the encoder/decoder.

For example, the small block described in this specification may be a square block having the same width and height, each ordered pair of width and height of which is (2, 2), (4,4), (8,8) or (16,16). In addition, the small block described in this specification may be a non-square block having different width and height, each ordered pair of width and height of which is (2,4), (2,8), (2,16), (4,8), (4,16), (8,16), (4,2), (8,2), (16,2), (8,4), (16,4) or (16,8). In addition, the small block described in this specification may be a non-square block, the width and height of which have a multiple or divisor relationship with each other.

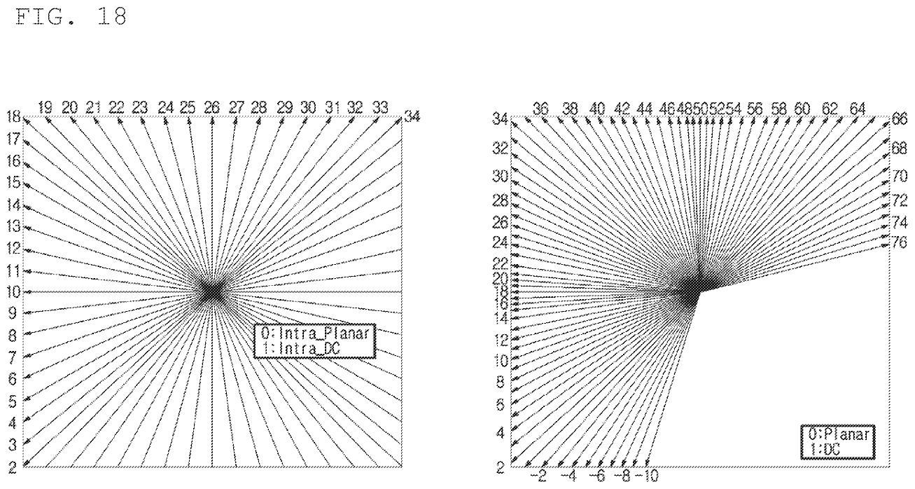

FIG. 20 is a view illustrating a method of reducing the number of intra prediction modes in intra prediction of a small block, according to an embodiment of the present invention.

As shown in FIG. 20(a), when the block in the encoder/decoder is not a small block, N1 intra prediction modes may be used. In addition, as shown in FIG. 20(b), when the block in the encoder/decoder is a small block, N2 intra prediction modes may be used. At this time, N1 and N2 may be respectively integers greater than or equal to 0 and N2 may be an integer less than N1. That is, in the small block, a smaller number of intra prediction modes may be used as compared to the case where the block is not a small block.

According to the present invention, examples of the method of decreasing the number of types of intra prediction modes include a method of using only even-numbered prediction modes, a method of using only odd-numbered prediction modes and a method of using only some of prediction mode numbers or reallocating prediction mode numbers. At least two of the method of using only even-numbered prediction modes, the method of using only odd-numbered prediction modes and the method of using only some of prediction mode numbers or reallocating prediction mode numbers may be combined, thereby decreasing the number of types of intra prediction modes.

In the image encoding/decoding method according to the embodiment of the present invention, when the current block is a small block, only the even-numbered intra prediction modes may be used. That is, when the current block is a small block, the intra prediction mode corresponding to the odd number may not be used. At this time, in the intra prediction mode corresponding to the odd number, some odd-numbered modes such as a DC_IDX (1) mode may be used.

For example, when the current block is a small block, a method of omitting a cost deriving and comparing process with respect to an odd-numbered intra prediction mode, a method of not adding an odd-numbered intra prediction mode to the MPM when the MPM is structured, a method of correcting an odd-numbered intra prediction mode to an even-numbered intra prediction mode when the MPM is structured, a method of adding an even-numbered intra prediction mode to the MPM when the MPM is structured and a method of using only the even-numbered intra prediction modes when non-MPM intra prediction is used may be used.

FIG. 21 is a view illustrating a method of omitting a cost deriving and comparing process with respect to an odd-numbered intra prediction mode when a current block is a small block, according to an embodiment of the present invention.

Referring to FIG. 21, when the current block is a small block (S2101—“true”), whether an intra prediction candidate mode has an odd number may be determined (S2102). When the current block is not a small block (S2101—“false”) or when the current block is a small block and the intra prediction candidate mode does not have an odd number (S2102—“false”), a process of performing intra prediction and a cost deriving and comparing process for the intra prediction candidate mode may be performed (S2103). That is, when the current block is a small block and the intra prediction candidate mode has an odd number, the cost deriving and comparing process for the intra prediction candidate mode may be omitted. As shown in FIG. 21, if some processes are omitted for the intra prediction candidate mode, computational complexity of the encoder may be reduced.

At this time, start and end shown in FIG. 21 may mean start and end of the process of performing intra prediction and the cost deriving and comparing process for one intra prediction candidate mode in the encoder. However, this may not mean start and end of the overall image coding process or start and end of the cost deriving/comparing process for all modes.

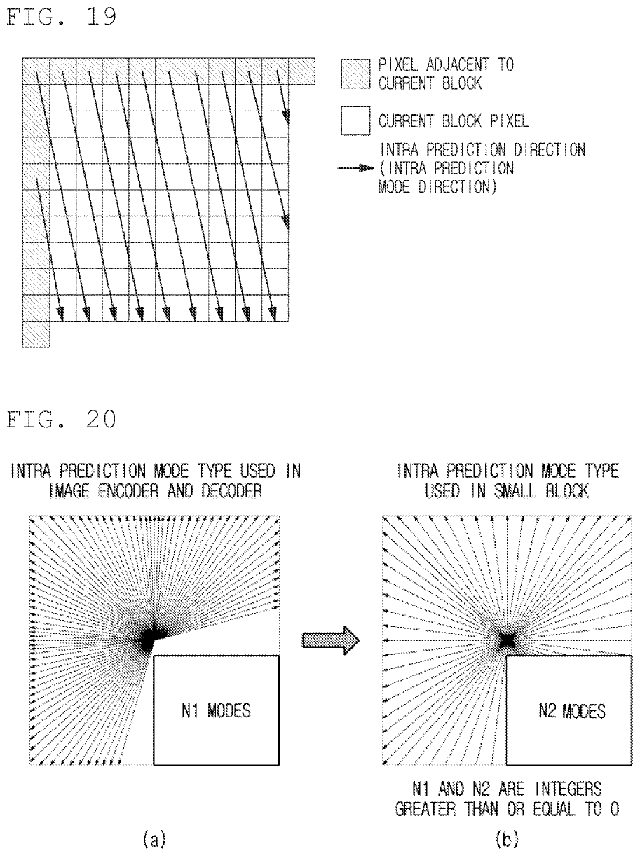

FIG. 22 is a view illustrating a method of not adding an odd-numbered intra prediction mode to the MPM upon structuring the MPM when the current block is a small block, according to an embodiment of the present invention.

In the case where the current block is a small block, when the MPM is structured in the encoder/decoder, the odd-numbered intra prediction mode may be excluded from the MPM candidates.

Referring to FIG. 22, when the current block is a small block (S2201—“true”), whether the intra prediction mode of the MPM candidate has an odd number may be determined (S2202). When the current block is not a small block (S2201—“false”) or when the current block is a small block and the intra prediction mode of the MPM candidate does not have an odd number (S2202—“false”), intra prediction mode of the MPM candidate may be added to the MPM (S2203). That is, when the current block is not a small block or when the current block is a small block and the intra prediction mode of the MPM candidate has an even number, the intra prediction mode of the MPM candidate may be added to the MPM.

At this time, start and end shown in FIG. 22 may mean start and end of the process of adding the intra prediction mode of one MPM candidate to the MPM in the encoder/decoder. However, this may not mean start and end of the overall image coding process or start and end of the entire MPM structuring. In addition, the intra prediction mode of the MPM candidate described in FIG. 22 may mean all intra prediction modes which may be structured in the MPM through a series of computations or the intra prediction mode of the neighbor block of the current block.

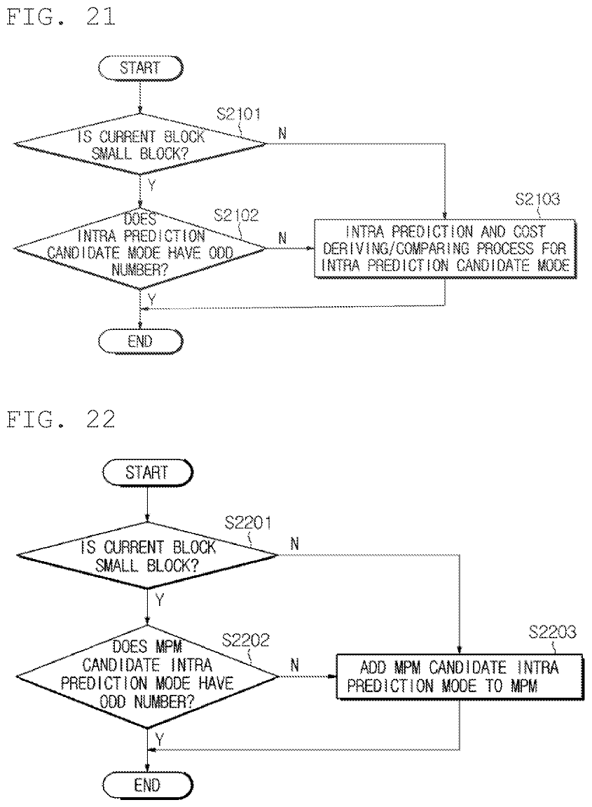

FIG. 23 is a view illustrating a method of correcting an odd-numbered intra prediction mode to an even-numbered intra prediction mode upon structuring the MPM when the current block is a small block, according to an embodiment of the present invention.

In the case where the current block is a small block, when the MPM is structured in the encoder/decoder, the odd-numbered intra prediction mode may be corrected to the even-numbered intra prediction mode through a series of computations. For example, when the intra prediction mode M1 added to the MPM has an odd number, the odd number may be corrected to the even number through a series of computations such as M1+1, M1−1 or (M1>>1)<<1, and the intra prediction mode having the even number may be added to the MPM. Alternatively, when M1 has an odd number, the odd number may be corrected to the even number through a series of computations such as M1+j or M1−j (at this time, j being an odd number), and the intra prediction mode having the even number may be added to the MPM.

Referring to FIG. 23, when the current block is a small block (S2301—“true”), whether the intra prediction mode of the MPM candidate has an odd number may be determined (S2302). In addition, when the intra prediction mode of the MPM candidate has an odd number (S2302—“true”), the odd number may be corrected to an even number through a series of computations and the intra prediction mode having the even number may be added to the MPM (S2303). When the current block is not a small block (S2301—“false”) or when the current block is a small block and the intra prediction mode of the MPM candidate does not have an odd number (S2302—“false”), the intra prediction mode of the MPM candidate may be added to the MPM (S2304). That is, when the current block is not a small block or when the current block is a small block and the intra prediction mode of the MPM candidate has an even number, the intra prediction mode of the MPM candidate may be added to the MPM.

At this time, start and end shown in FIG. 23 may mean start and end of the process of adding the intra prediction mode of one MPM candidate to the MPM in the encoder/decoder. However, this may not mean start and end of the overall image coding process or start and end of entire MPM structuring. In addition, the intra prediction mode of the MPM candidate described in FIG. 23 may mean all intra prediction modes which may be structured in the MPM through a series of computations or the intra prediction mode of the neighbor block of the current block.

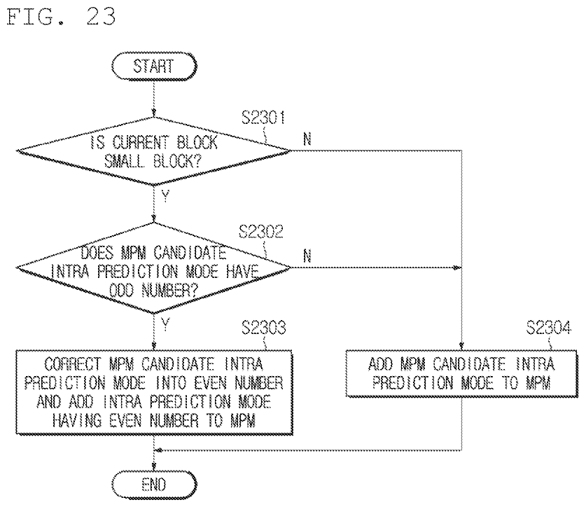

FIG. 24 is a view illustrating a method of adding an even-numbered intra prediction mode to the MPM upon structuring the MPM when the current block is a small block, according to an embodiment of the present invention.

In the case where the current block is a small block, when the MPM is structured in the encoder/decoder, only the even-numbered intra prediction mode may be added to the MPM. The embodiment described in FIG. 23 is different from the present embodiment in that, in FIG. 23, the intra prediction mode of the existing MPM candidate may be corrected to the even-numbered intra prediction mode and the even-numbered intra prediction mode may be added to the MPM. However, in the present embodiment, in the case where there is a computation capable of deriving the odd-numbered candidate in the existing MPM structuring method, another method of deriving an even-numbered intra prediction mode may be used instead of the corresponding computation.

For example, for M1 which is one of the intra prediction modes having the even number of the neighbor block, when the existing MPM structuring is a method of adding M1+1 and M1−1 to the MPM, M1+1 and M1−1 become odd-numbered intra prediction modes. At this time, according to the present embodiment, other computations such as M1+2 and M1−2 may be used to add the even-numbered intra prediction mode to the MPM. Alternatively, computations such as M1+i and M1−i (at this time, i being an even number) may be used to add the even-numbered intra prediction mode to the MPM.

In addition, the even-numbered intra prediction mode may be immediately added to the MPM without performing a series of computations.

Referring to FIG. 24, when the current block is a small block (S2401—“true”), the even-numbered intra prediction mode may be added to the MPM (S2402). When the current block is not a small block (S2401—“false”), the MPM candidate may be added to the MPM according to the existing MPM structuring method (S2403).

At this time, start and end shown in FIG. 24 may mean start and end of the process of adding the intra prediction mode of one MPM candidate to the MPM in the encoder/decoder. However, this may not mean start and end of the overall image coding process or start and end of entire MPM structuring. In addition, the intra prediction mode of the MPM candidate described in FIG. 24 may mean all intra prediction modes which may be structured in the MPM through a series of computations or the intra prediction mode of the neighbor block of the current block.

FIG. 25 is a view illustrating a method of using only even-numbered intra prediction modes to perform non-MPM encoding/decoding when the current block is a small block, according to an embodiment of the present invention.

Referring to FIG. 25, when the current block is a small block (S2501—“true”), only the even-numbered intra prediction mode may be used to perform the non-MPM encoding/decoding method (S2502). When the current block is not a small block (S2501—“false”), the existing non-MPM encoding/decoding method may be performed (S2503). The existing non-MPM encoding/decoding method may mean a method of performing non-MPM encoding/decoding regardless of whether the intra prediction mode has an even number or an odd number, in performing of encoding/decoding. At this time, non-MPM intra prediction may mean intra prediction without using the MPM. Here, since only the even-numbered intra prediction mode is used, the intra prediction mode may be halved, a method of allocating fewer bits may be used in encoding/decoding.

At this time, start and end shown in FIG. 25 may mean start and end of the non-MPM encoding/decoding process in the encoder/decoder. However, this may not mean the overall image coding process.

In the image encoding/decoding method according to the embodiment of the present invention, when the current block is a small block, only the odd-numbered intra prediction mode may be used. That is, when the current block is a small block, the intra prediction mode corresponding to the even number may not be used. At this time, in the intra prediction mode corresponding to the even number, some even-numbered modes such as PLANAR (0) mode may be used.

For example, when the current block is a small block, a method of omitting a cost deriving and comparing process with respect to an even-numbered intra prediction mode, a method of not adding an even-numbered intra prediction mode to the MPM when the MPM is structured, a method of correcting an even-numbered intra prediction mode to an odd-numbered intra prediction modes when the MPM is structured, a method of adding an odd-numbered intra prediction mode to the MPM when the MPM is structured and a method of using only the odd-numbered intra prediction mode when non-MPM intra prediction is used may be used.

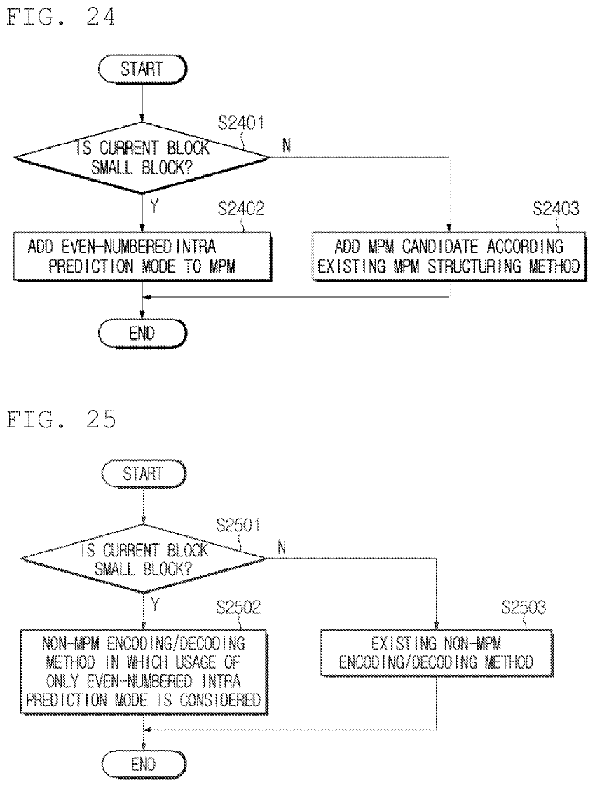

FIG. 26 is a view illustrating a method of omitting a cost deriving and comparing process with respect to an even-numbered intra prediction mode when a current block is a small block, according to an embodiment of the present invention.

Referring to FIG. 26, when the current block is a small block (S2601—“true”), whether an intra prediction candidate mode has an even number may be determined (S2602). When the current block is not a small block (S2601—“false”) or when the current block is a small block and the intra prediction candidate mode does not have an even number (S2602—“false”), a process of performing intra prediction and a cost deriving and comparing process for the intra prediction candidate mode may be performed (S2603). That is, when the current block is a small block and the intra prediction candidate mode has an even number, the cost deriving and comparing process for the intra prediction candidate mode may be omitted. As shown in FIG. 26, if some processes are omitted for the intra prediction candidate mode, computational complexity of the encoder may be reduced.

At this time, start and end shown in FIG. 26 may mean start and end of the process of performing intra prediction and the cost deriving and comparing process for one intra prediction candidate mode in the encoder. However, this may not mean start and end of the overall image coding process or start and end of the cost deriving/comparing process for all modes.

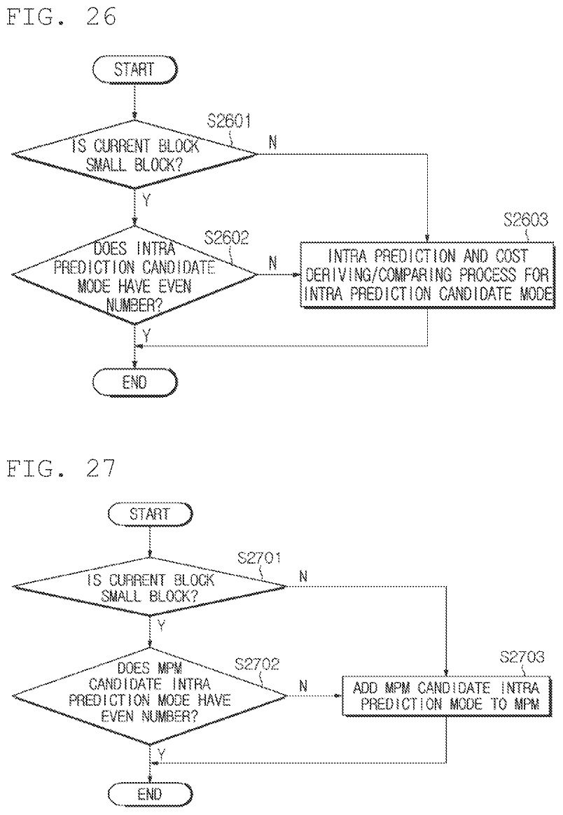

FIG. 27 is a view illustrating a method of not adding an even-numbered intra prediction mode to the MPM upon structuring the MPM when the current block is a small block, according to an embodiment of the present invention.

In the case where the current block is a small block, when the MPM is structured in the encoder/decoder, the even-numbered intra prediction mode may be excluded from the MPM candidates.

Referring to FIG. 27, when the current block is a small block (S2701—“true”), whether the intra prediction mode of the MPM candidate has an even number may be determined (S2702). When the current block is not a small block (S2701—“false”) or when the current block is a small block and the intra prediction mode of the MPM candidate does not have an even number (S2702—“false”), intra prediction mode of the MPM candidate may be added to the MPM (S2703). That is, when the current block is not a small block or when the current block is a small block and the intra prediction mode of the MPM candidate has an odd number, the intra prediction mode of the MPM candidate may be added to the MPM.

At this time, start and end shown in FIG. 27 may mean start and end of the process of adding the intra prediction mode of one MPM candidate to the MPM in the encoder/decoder. However, this may not mean start and end of the overall image coding process or start and end of the entire MPM structuring. In addition, the intra prediction mode of the MPM candidate described in FIG. 27 may mean all intra prediction modes which may be structured in the MPM through a series of computations or the intra prediction mode of the neighbor block of the current block.

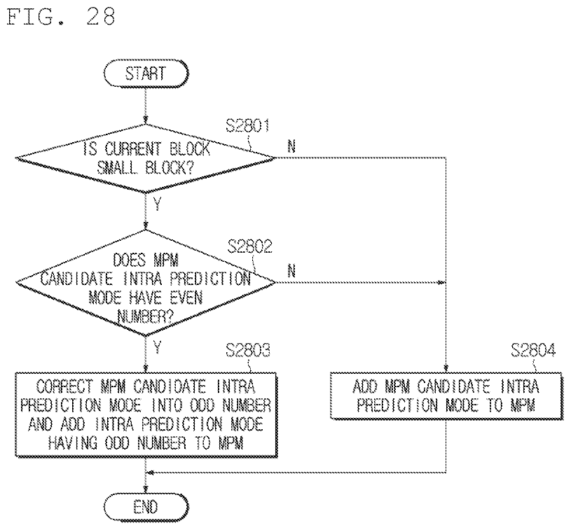

FIG. 28 is a view illustrating a method of correcting an even-numbered intra prediction mode to an odd-numbered intra prediction mode upon structuring the MPM when the current block is a small block, according to an embodiment of the present invention.

In the case where the current block is a small block, when the MPM is structured in the encoder/decoder, the even-numbered intra prediction mode may be corrected to the odd-numbered intra prediction mode through a series of computations. For example, when the intra prediction mode M1 added to the MPM has an even number, the even number may be corrected to the odd number through a series of computations such as M1+1 and M1−1, and the intra prediction mode having the odd number may be added to the MPM. Alternatively, when M1 has an even number, the even number may be corrected to the odd number through a series of computations such as M1+j or M1−j (at this time, j being an odd number), and the intra prediction mode having the odd number may be added to the MPM.

Referring to FIG. 28, when the current block is a small block (S2801—“true”), whether the intra prediction mode of the MPM candidate has an even number may be determined (S2802). In addition, when the intra prediction mode of the MPM candidate has an even number (S2802—“true”), the even number may be corrected to an odd number through a series of computations and the intra prediction mode having the odd number may be added to the MPM (S2803). When the current block is not a small block (S2801—“false”) or when the current block is a small block and the intra prediction mode of the MPM candidate does not have an even number (S2802—“false”), the intra prediction mode of the MPM candidate may be added to the MPM (S2804). That is, when the current block is not a small block or when the current block is a small block and the intra prediction mode of the MPM candidate has an odd number, the intra prediction mode of the MPM candidate may be added to the MPM.

At this time, start and end shown in FIG. 28 may mean start and end of the process of adding the intra prediction mode of one MPM candidate to the MPM in the encoder/decoder. However, this may not mean start and end of the overall image coding process or start and end of entire MPM structuring. In addition, the intra prediction mode of the MPM candidate described in FIG. 28 may mean all intra prediction modes which may be structured in the MPM through a series of computations or the intra prediction mode of the neighbor block of the current block.

FIG. 29 is a view illustrating a method of adding an odd-numbered intra prediction mode to the MPM upon structuring the MPM when the current block is a small block, according to an embodiment of the present invention.

In the case where the current block is a small block, when the MPM is structured in the encoder/decoder, only the odd-numbered intra prediction mode may be added to the MPM. The embodiment described in FIG. 28 is different from the present embodiment in that, in FIG. 28, the intra prediction mode of the existing MPM candidate may be corrected to the odd-numbered intra prediction mode and the odd-numbered intra prediction mode may be added to the MPM. However, in the present embodiment, in the case where there is a computation capable of deriving the even-numbered candidate in the existing MPM structuring method, another method of deriving an odd-numbered intra prediction mode may be used instead of the corresponding computation.

For example, for M1 which is one of the intra prediction modes having the odd number of the neighbor block, when the existing MPM structuring is a method of adding M1+1 and M1−1 to the MPM, M1+1 and M1−1 become even-numbered intra prediction modes. At this time, according to the present embodiment, other computations such as M1+2 and M1−2 may be used to add the odd-numbered intra prediction mode to the MPM. Alternatively, computations such as M1+i and M1−i (at this time, i being an even number) may be used to add the odd-numbered intra prediction mode to the MPM.

In addition, the odd-numbered intra prediction mode may be immediately added to the MPM without performing a series of computations.

Referring to FIG. 29, when the current block is a small block (S2901—“true”), the odd-numbered intra prediction mode may be added to the MPM (S2902). When the current block is not a small block (S2901—“false”), the MPM candidate may be added to the MPM according to the existing MPM structuring method (S2903).

At this time, start and end shown in FIG. 29 may mean start and end of the process of adding the intra prediction mode of one MPM candidate to the MPM in the encoder/decoder. However, this may not mean start and end of the overall image coding process or start and end of entire MPM structuring. In addition, the intra prediction mode of the MPM candidate described in FIG. 29 may mean all intra prediction modes which may be structured in the MPM through a series of computations or the intra prediction mode of the neighbor block of the current block.

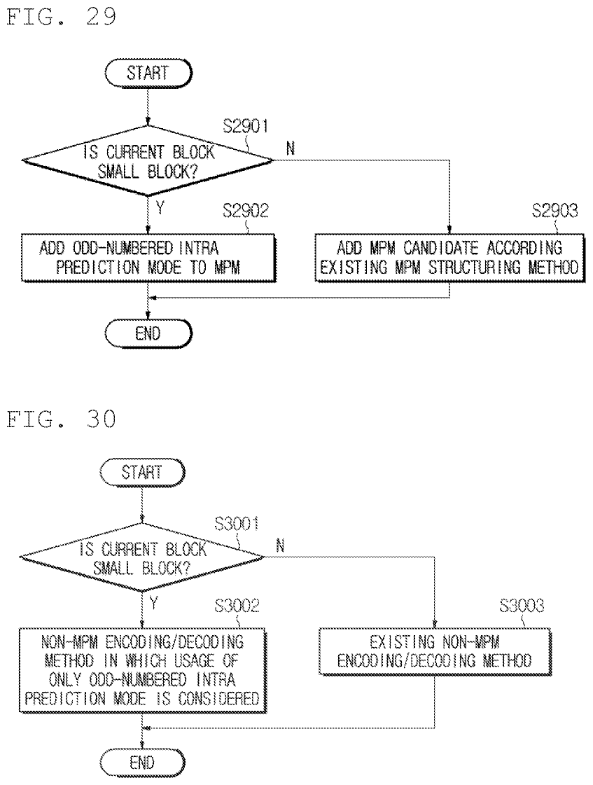

FIG. 30 is a view illustrating a method of using only odd-numbered intra prediction modes to perform non-MPM encoding/decoding when the current block is a small block, according to an embodiment of the present invention.

Referring to FIG. 30, when the current block is a small block (S3001—“true”), only the odd-numbered intra prediction mode may be used to perform the non-MPM encoding/decoding method (S3002). When the current block is not a small block (S3001—“false”), the existing non-MPM encoding/decoding method may be performed (S3003). The existing non-MPM encoding/decoding method may mean a method of performing non-MPM encoding/decoding regardless of whether the intra prediction mode has an even number or an odd number, in performing of encoding/decoding. At this time, non-MPM intra prediction may mean intra prediction without using the MPM. Here, since only the odd-numbered intra prediction mode is used, the intra prediction mode may be halved, a method of allocating fewer bits may be used in encoding/decoding.

At this time, start and end shown in FIG. 30 may mean start and end of the non-MPM encoding/decoding process in the encoder/decoder. However, this may not mean the overall image coding process.

In the image encoding/decoding method according to the embodiment of the present invention, when the current block is a small block, some intra prediction modes may not be used. That is, when the current block is a small block, some intra prediction modes which are predetermined not to be used may not be used. At this time, some intra prediction modes which are predetermined not to be used are not limited to the intra prediction mode having an even or odd number, and may be partial intra prediction modes which are not divided in odd and even numbers. In addition, these may be the intra prediction modes which are not statistically used well in small blocks.

For example, when the current block is a small block, a method of omitting a cost deriving and comparing process with respect to some intra prediction modes which are predetermined not to be used, a method of not adding some intra prediction modes which are predetermined not to be used to the MPM when the MPM is structured, a method of correcting some intra prediction modes, which are predetermined not to be used, to the other modes when the MPM is structured, a method of adding intra prediction mode candidates except for some intra prediction modes, which are predetermined not to be used, to the MPM when the MPM is structured and a method of using only some intra prediction modes when non-MPM intra prediction is used may be used.

FIG. 31 is a view illustrating a method of omitting a cost deriving and comparing process with respect some intra prediction modes, which are predetermined not to be used, when a current block is a small block, according to an embodiment of the present invention.

Referring to FIG. 31, when the current block is a small block (S3101—“true”), whether an intra prediction candidate mode is a mode predetermined not to be used may be determined (S3102). When the current block is not a small block (S3101—“false”) or when the current block is a small block and the intra prediction candidate mode is not a mode predetermined not to be used (S3102—“false”), a process of performing intra prediction and a cost deriving and comparing process for the intra prediction candidate mode may be performed (S3103). That is, when the current block is a small block and the intra prediction candidate mode is a mode predetermined not to be used, the cost deriving and comparing process for the intra prediction candidate mode may be omitted. As shown in FIG. 31, if some processes are omitted for the intra prediction candidate mode, computational complexity of the encoder may be reduced.

At this time, start and end shown in FIG. 31 may mean start and end of the process of performing intra prediction and the cost deriving and comparing process for one intra prediction candidate mode in the encoder. However, this may not mean start and end of the overall image coding process or start and end of the cost deriving/comparing process for all modes.

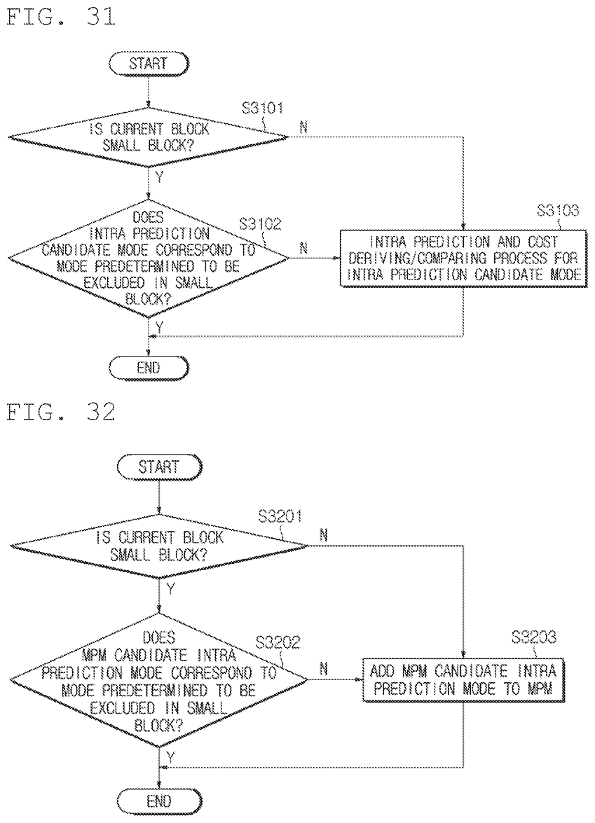

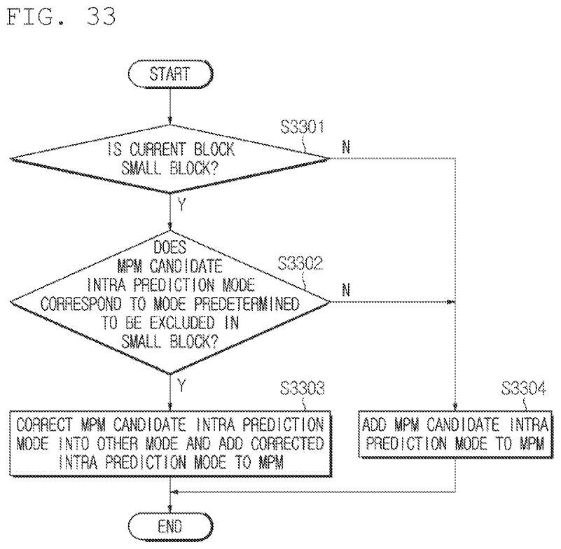

FIG. 32 is a view illustrating a method of not adding some intra prediction modes, which are predetermined not to be used, to the MPM upon structuring the MPM when the current block is a small block, according to an embodiment of the present invention.

In the case where the current block is a small block, when the MPM is structured in the encoder/decoder, some intra prediction modes, which are predetermined not to be used, may be excluded from the MPM candidates.

Referring to FIG. 32, when the current block is a small block (S3101—“true”), whether the intra prediction modes of the MPM candidate are some intra prediction modes which are predetermined not to be used (S3202). When the current block is not a small block (S3201—“false”) or when the current block is a small block and the intra prediction modes of the MPM candidate are not some intra prediction modes which are predetermined not to be used (S3202—“false”), intra prediction mode of the MPM candidate may be added to the MPM (S3203). That is, when the current block is not a small block or when the current block is a small block and the intra prediction modes of the MPM candidate are not some intra prediction modes which are predetermined not to be used, the intra prediction modes of the MPM candidate may be added to the MPM.

At this time, start and end shown in FIG. 32 may mean start and end of the process of adding the intra prediction mode of one MPM candidate to the MPM in the encoder/decoder. However, this may not mean start and end of the overall image coding process or start and end of the entire MPM structuring. In addition, the intra prediction mode of the MPM candidate described in FIG. 32 may mean all intra prediction modes which may be structured in the MPM through a series of computations or the intra prediction mode of the neighbor block of the current block.

FIG. 33 is a view illustrating a method of correcting some intra prediction modes, which are predetermined not to be used, to the other modes upon structuring the MPM when the current block is a small block, according to an embodiment of the present invention.

In the case where the current block is a small block, when the MPM is structured in the encoder/decoder, some intra prediction modes, which are predetermined not to be used, may be corrected to the other modes through a series of computations.

Referring to FIG. 33, when the current block is a small block (S3301—“true”), whether the intra prediction modes of the MPM candidate are some intra prediction modes which are predetermined not to be used in the small block (S3302). In addition, when the intra prediction modes of the MPM candidate are some intra prediction modes which are predetermined not to be used in the small block (S3302—“true”), the corresponding MPM mode may be corrected to the modes except for some intra prediction modes which are predetermined not to be used in the small block through a series of computations and the corrected modes may be added to the MPM (S3303). When the current block is not a small block (33301—“false”) or when the current block is a small block and is not the intra prediction mode predetermined not to be used in the small block (S3302—“false”), the intra prediction mode of the MPM candidate may be added to the MPM (S3304).

At this time, start and end shown in FIG. 33 may mean start and end of the process of adding the intra prediction mode of one MPM candidate to the MPM in the encoder/decoder. However, this may not mean start and end of the overall image coding process or start and end of entire MPM structuring. In addition, the intra prediction mode of the MPM candidate described in FIG. 33 may mean all intra prediction modes which may be structured in the MPM through a series of computations or the intra prediction mode of the neighbor block of the current block.

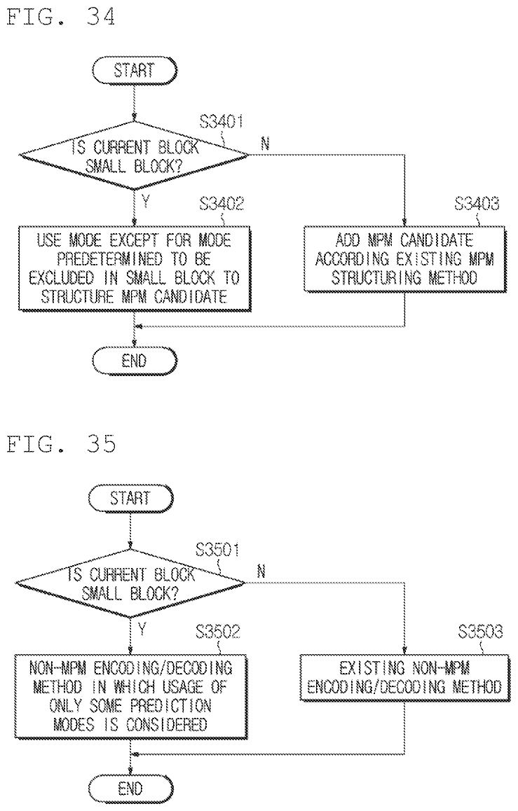

FIG. 34 is a view illustrating a method of adding the intra prediction candidate mode except for the intra prediction candidate mode, which is predetermined not to be used, to the MPM upon structuring the MPM when the current block is a small block, according to an embodiment of the present invention.

In the case where the current block is a small block, when the MPM is structured in the encoder/decoder, the intra prediction candidate mode except for the intra prediction candidate mode predetermined not to be used in the small block may be added to the MPM. In addition, the intra prediction candidate mode except for the intra prediction candidate mode predetermined not to be used in the small block may be immediately added to the MPM without performing a series of computations.

Referring to FIG. 34, when the current block is a small block (S3401—“true”), the intra prediction candidate mode except for the intra prediction candidate mode predetermined not to be used in the small block may be added to the MPM (S3402). When the current block is not a small block (S3401—“false”), the MPM candidate may be added to the MPM according to the existing MPM structuring method (S3403).

At this time, start and end shown in FIG. 34 may mean start and end of the process of adding the intra prediction mode of one MPM candidate to the MPM in the encoder/decoder. However, this may not mean start and end of the overall image coding process or start and end of entire MPM structuring. In addition, the intra prediction mode of the MPM candidate described in FIG. 34 may mean all intra prediction modes which may be structured in the MPM through a series of computations or the intra prediction mode of the neighbor block of the current block.

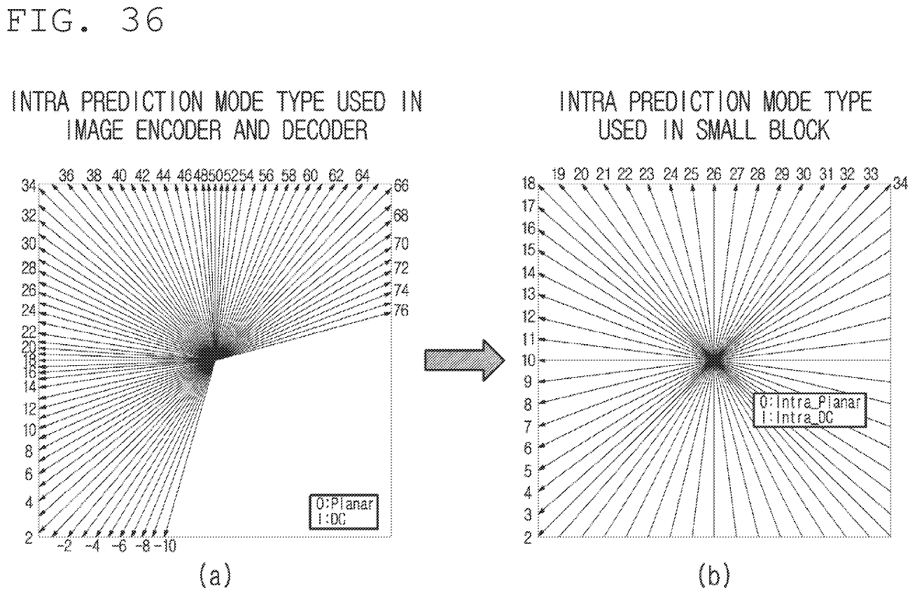

FIG. 35 is a view illustrating a method of using only some intra prediction modes to perform non-MPM encoding/decoding when the current block is a small block, according to an embodiment of the present invention.

Referring to FIG. 35, when the current block is a small block (S3501—“true”), only some intra prediction modes may be used to perform the non-MPM encoding/decoding method (S3502). When the current block is not a small block (S3501—“false”), the existing non-MPM encoding/decoding method may be performed (S3503). The existing non-MPM encoding/decoding method may mean a method capable of using all intra prediction modes in performing of encoding/decoding. At this time, non-MPM intra prediction may mean intra prediction without using the MPM. Here, since only some intra prediction modes are used, the intra prediction mode may be halved, a method of allocating fewer bits may be used in encoding/decoding.

At this time, start and end shown in FIG. 35 may mean start and end of the non-MPM encoding/decoding process in the encoder/decoder. However, this may not mean the overall image coding process.

In the image encoding/decoding method according to the embodiment of the present invention, when the current block is a small block, the intra prediction mode number may be reallocated according to directionality.

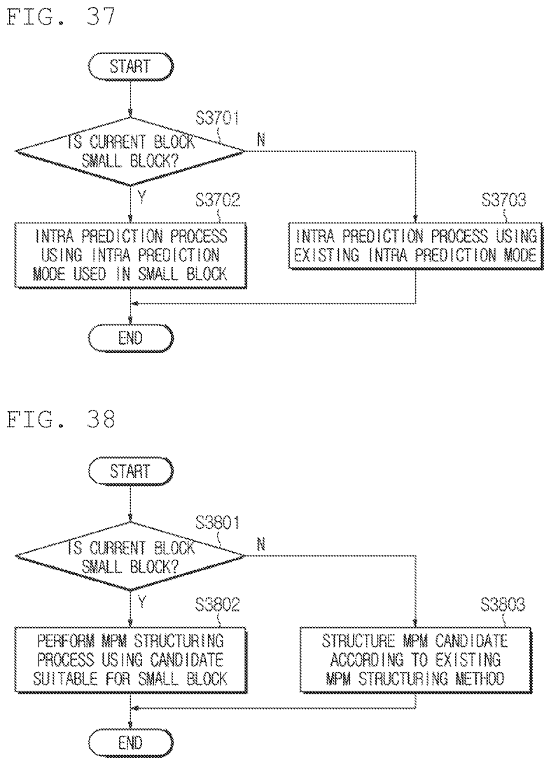

FIG. 36 is a view showing an embodiment in which the intra prediction mode number is allocated.

In the encoder/decoder, as shown in FIG. 36(a), the intra prediction mode number may be allocated. At this time, when the current block is a small block, as shown in FIG. 36(b), the intra prediction mode number may be reallocated.

FIG. 37 is a view illustrating a method of using the intra prediction mode number reallocated according to directionality when the current block is a small block, according to an embodiment of the present invention.

Referring to FIG. 37, when the current block is a small block (S3701—“true”), the intra prediction mode used in the small block may be used to perform intra prediction (S3702). For example, when the current block is a small block, the intra prediction mode reallocated according to directionality may be used to perform intra prediction. When the current block is not a small block (S3701—“false”), the existing intra prediction mode may be used to perform intra prediction (S3703).

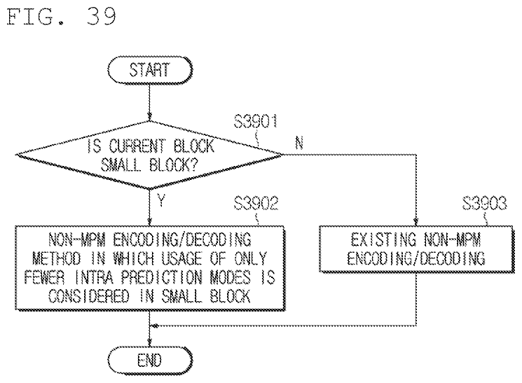

FIG. 38 is a view illustrating a method of structuring an MPM using candidates suitable for a small block upon structuring the MPM when the current block is a small block, according to an embodiment of the present invention.

Referring to FIG. 38, when the current block is a small block (S3801—“true”), a process of structuring the MPM using candidates suitable for the small block may be performed (S3802). When the current block is not a small block (S3801—“false”), the MPM candidate may be structured according to the existing MPM structuring method (S3803).

At this time, start and end shown in FIG. 38 may mean start and end of the process of adding the intra prediction mode of one MPM candidate to the MPM in the encoder/decoder. However, this may not mean start and end of the overall image coding process or start and end of the entire MPM structuring. In addition, the intra prediction mode of the MPM candidate described in FIG. 38 may mean all intra prediction modes which may be structured in the MPM through a series of computations or the intra prediction mode of the neighbor block of the current block.

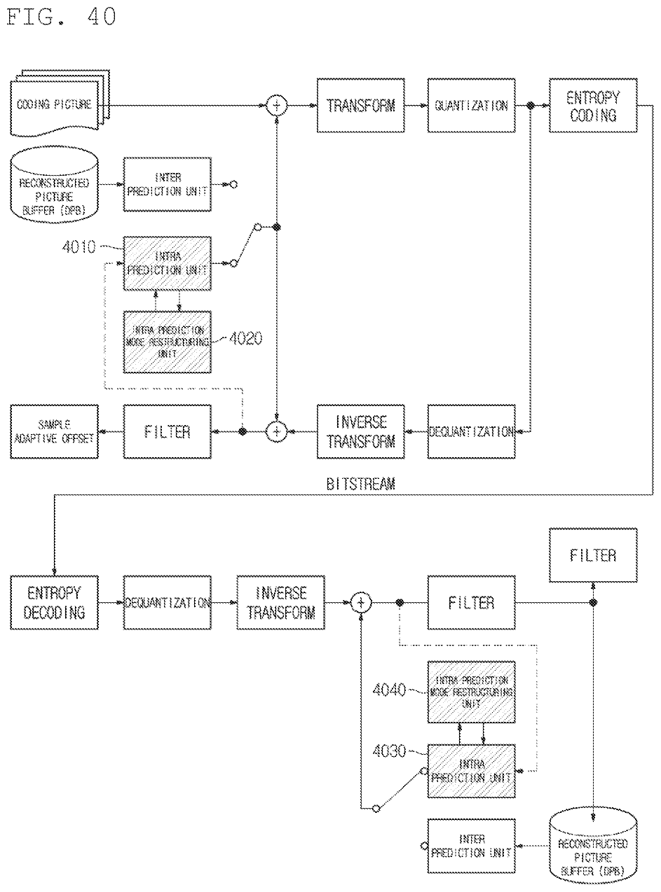

FIG. 39 is a view illustrating a method of using intra prediction modes less in number than the number of existing intra prediction modes to perform non-MPM encoding/decoding when the current block is a small block, according to an embodiment of the present invention.

Referring to FIG. 39, when the current block is a small block (S3901—“true”), the intra prediction modes less in number than the number of existing intra prediction modes may be used to perform non-MPM encoding/decoding (S3902). When the current block is not a small block (S3901—“false”), the existing non-MPM encoding/decoding method may be performed (S3903). At this time, non-MPM intra prediction may mean intra prediction which does not use the MPM. Here, in the small bock, since only the intra prediction modes less in number than the number of existing intra prediction modes are used, a method of allocating fewer bits upon encoding/decoding may be used.

At this time, start and end shown in FIG. 39 may mean start and end of the non-MPM encoding/decoding process in the encoder/decoder. However, this may not mean start/end of the overall image coding process.

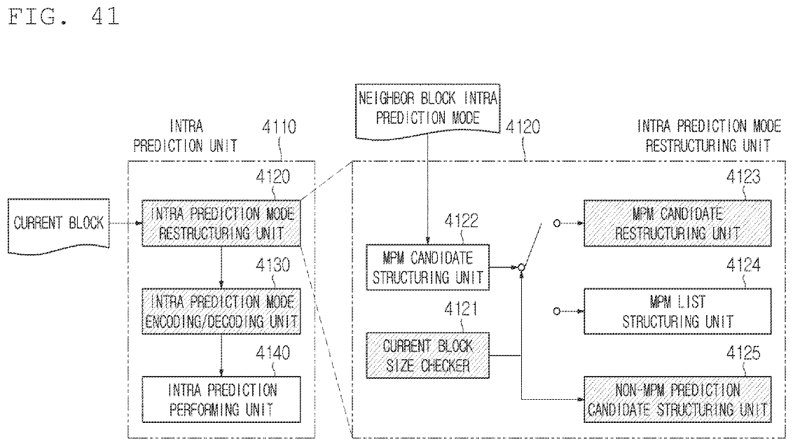

FIG. 40 is a view showing the configuration of a encoder/decoder in which a restructured intra prediction mode is used when the current block is a small block, according to an embodiment of the present invention.

Referring to FIG. 40, when the current block is a small block, in an intra prediction unit 4010 of the encoder, the intra prediction mode restructured in an intra prediction mode restructuring unit 4020 may be used to perform intra prediction. In addition, when the current block is a small block, in an intra prediction unit 4030 of the decoder, the intra prediction mode restructured in an intra prediction mode restructuring unit 4040 may be used to perform intra prediction.

At this time, in the intra prediction mode restructuring units 4020 and 4040, at least one of methods of using restricted intra prediction modes such as a method of using only even-numbered prediction modes in the small block, a method of using only odd-numbered prediction modes, a method of using only some of prediction mode numbers and a method of reallocating prediction mode numbers or a method of using restructured intra prediction modes may be used.

FIG. 41 is a view showing structuring in which an intra prediction mode restructuring unit is applied to an intra prediction unit, according to an embodiment of the present invention.

Referring to FIG. 41, an intra prediction unit 4110 may correspond to the intra prediction units 4010 and 4030 of FIG. 40, and an intra prediction mode restructuring unit 4120 may correspond to the intra prediction mode restructuring units 4020 and 4040 of FIG. 40.

The intra prediction unit 4110 according to the embodiment of the present invention may include the intra prediction mode restructuring unit 4120, an intra prediction mode encoding/decoding unit 4130 and an intra prediction performing unit 4140.

In addition, the intra prediction mode restructuring unit 4120 may include a current block size checker 4121, an MPM candidate structuring unit 4122, an MPM candidate restructuring unit 4123, an MPM list structuring unit 4124 and a non-MPM prediction candidate structuring unit 4125.

The intra prediction mode restructuring unit 4120 may restructure the intra prediction mode through information on a current block. At this time, the information on the current block may include information indicating whether the current block is a small block.

The current block size checker 4121 may determine whether the intra prediction mode is restructured according to the size of the current block. In addition, the current block size checker 4121 may check the size of the current block in order to change the restructuring method of the intra prediction mode and determine whether candidate restructuring is performed or a candidate restructuring method.

The MPM candidate structuring unit 4122 may determine MPM candidates to be used preferentially according to the intra prediction mode of the neighbor block and a predefined MPM structuring method. At this time, the candidate determined by the MPM candidate structuring unit 4122 may be restructured by the MPM candidate restructuring unit 4123 according to whether candidate restructuring is performed or the candidate restructuring method, which is determined the current block size checker 4121.

For example, when the current block size checker 4121 determines that the current block is a small block and determine that the MPM candidate is restructured, the MPM candidate restructuring unit 4123 may restructure the MPM candidate determined by the MPM candidate structuring unit 4122. At this time, the method of restructuring the MPM candidate may include at least one of methods of restricted intra prediction modes such as a method of using only even-numbered prediction modes in the small block, a method of using only odd-numbered prediction modes, a method of using only some of prediction mode numbers and a method of reallocating prediction mode numbers or a method of using restructured intra prediction modes.

The MPM list structuring unit 4124 may structure an MPM list to be used for encoding/decoding of the intra prediction mode from finally determined MPM candidates. At this time, when it is determined that the MPM candidates are restructured by the current block size checker 4121, the MPM candidates restructured from the MPM candidate restructuring unit 4123 may be used, thereby structuring the MPM list. In contrast, when it is determined that the MPM candidates are not restructured by the current block size checker 4121, the MPM candidates structured by the MPM candidate structuring unit 4122 may be used, thereby structuring the MPM list.

At this time, the MPM candidate structuring unit 4122, the MPM candidate restructuring unit 4123 and the MPM list structuring unit 4124 may be wholly or partially combined or omitted.

The non-MPM prediction candidate structuring unit 4125 may structure non-MPM prediction candidates using candidates which do not belong to the MPM list and use the non-MPM prediction candidates during encoding/decoding of the intra prediction mode. At this time, when the current block size checker 4121 determines whether the intra prediction mode is restructured or the intra prediction mode restructuring method, the method of determining non-MPM prediction candidates or the priority of the non-MPM prediction candidates may be changed.

For example, when the current block is a small block, as the method of determining the non-MPM prediction candidates, at least one of methods of restricted intra prediction modes such as a method of using only even-numbered prediction modes in the small block, a method of using only odd-numbered prediction modes, a method of using only some of prediction mode numbers and a method of reallocating prediction mode numbers or a method of using restructured intra prediction modes may be used.

The intra prediction mode encoding/decoding unit 4130 may determine and code the prediction mode to be performed in the current block in consideration of the MPM list and the non-MPM prediction candidates or decode the prediction modes to be performed in the coded current block in consideration of the MPM list and the non-MPM prediction candidates. At this time, in the intra prediction mode encoding/decoding unit 4130, whether to restructure the intra prediction mode may be determined by the intra prediction mode restructuring unit 4120, thereby changing the encoding/decoding process.

The intra prediction performing unit 4140 may perform intra prediction according to the prediction mode of the current block determined by the intra prediction mode encoding/decoding unit 4130.

The above embodiments may be performed in the same method in an encoder and a decoder.

At least one or a combination of the above embodiments may be used to encode/decode a video.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 only. For example, the above embodiments may be applied when a size of current block is 16×16 or smaller. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied, a corresponding identifier may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type or a tile group type to which the above embodiments of the present invention are applied may be defined, and the above embodiments may be applied depending on the corresponding slice type or tile group type.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and structured for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used to encode or decode an image.

1. A method of decoding an image, the method comprising:
structuring a motion information candidate list of a current block;
selecting a first motion information candidate used for prediction of a first subblock in the current block from the motion information candidate list;
selecting a second motion information candidate used for prediction of a second subblock in the current block from the motion information candidate list;
generating a prediction sample of the first subblock by performing inter prediction with respect to the first subblock based on the first motion information candidate; and
generating a prediction sample of the second subblock by performing inter prediction with the second subblock based on the second motion information candidate,
wherein the first motion information candidate is any one of candidates in a first prediction direction in the motion information candidate list, and
wherein the second motion information candidate is any one of candidates in a second prediction direction in the motion information candidate list.

2. The method of claim 1, further comprising obtaining a first index for the first subblock and a second index for the second subblock from a bitstream,
wherein the first index is used for selecting the first motion information candidate from among the candidates in the first prediction direction, and
wherein the second index is used for selecting the second motion information candidate from among the candidates in the second prediction direction.

3. The method of claim 1, wherein the motion information candidate list includes at least one of motion information of a spatial neighbor block, motion information of a temporal neighbor block, combined motion information or zero motion information.

4. The method of claim 2, wherein the first index and the second index are different.

5. The method of claim 2,
wherein the first prediction direction is determined based on the first index, and
wherein the second prediction direction is determined based on the second index.

6. The method of claim 2,
wherein the first prediction direction is determined as an L0 direction when the first index is an even number, and
wherein the second prediction direction is determined as an L0 direction when the second index is an even number.

7. The method of claim 2,
wherein the first prediction direction is determined as an L1 direction when the first index is an odd number, and
wherein the second prediction direction is determined as an L1 direction when the second index is an odd number.

8. The method of claim 1, further comprising obtaining indices of partitioning directions of the current block from a bitstream,
wherein the number of partitioning directions is 64.

9. The method of claim 1, further comprising predicting the current block by weighted-summing the prediction sample of the first subblock and the prediction sample of the second subblock on boundaries of the first subblock and the second subblock.

10. A method of encoding an image, the method comprising:
structuring a motion information candidate list of a current block;
selecting a first motion information candidate used for prediction of a first subblock in the current block from the motion information candidate list; and
selecting a second motion information candidate used for prediction of a second subblock in the current block from the motion information candidate list,
wherein the first motion information candidate is any one of candidates in a first prediction direction in the motion information candidate list, and
wherein the second motion information candidate is any one of candidates in a second prediction direction in the motion information candidate list.

11. The method of claim 10, further comprising encoding a first index for the first subblock and a second index for the second subblock,
wherein the first index is used for selecting the first motion information candidate from the motion information candidate list, and
wherein the second index is used for selecting the second motion information candidate from the motion information candidate list.

12. The method of claim 10, wherein the motion information candidate list includes at least one of motion information of a spatial neighbor block, motion information of a temporal neighbor block, combined motion information or zero motion information.

13. The method of claim 11, wherein the first index and the second index are different.

14. The method of claim 11,
wherein the first prediction direction is determined based on the first index, and
wherein the second prediction direction is determined based on the second index.

15. The method of claim 11,
wherein the first prediction direction is determined as an L0 direction when the first index is an even number, and
wherein the second prediction direction is determined as an L0 direction when the second index is an even number.

16. The method of claim 11,
wherein the first prediction direction is determined as an L1 direction when the first index is an odd number, and
wherein the second prediction direction is determined as an L1 direction when the second index is an odd number.

17. The method of claim 10, further comprising encoding indices of partitioning directions of the current block,
wherein the number of partitioning directions is 64.

18. A non-transitory computer-readable recording medium for storing a bitstream generated by a method of encoding an image, the method comprising:
structuring a motion information candidate list of a current block;
selecting a first motion information candidate used for prediction of a first subblock in the current block from the motion information candidate list; and
selecting a second motion information candidate used for prediction of a second subblock in the current block from the motion information candidate list,
wherein the first motion information candidate is any one of candidates in a first prediction direction in the motion information candidate list, and
wherein the second motion information candidate is any one of candidates in a second prediction direction in the motion information candidate list.
